(19) United States
(12) Patent Application Publication
(10) Pub. No.: US 2005/0095373 A1
(43) Pub. Date: May 5, 2005

(54) Optical compensatory sheet comprising cellulose acylate film

(75) Inventor: Yoji Ito, Kanagawa (JP)

Correspondence Address: BURNS DOANE SWECKER & MATHIS L L P, POST OFFICE BOX 1404, ALEXANDRIA, VA, 22313-1404, US

(73) Assignee: Fuji Photo Film Co., Ltd., Minami-ashigara-shi (JP)

(21) Appl. No.: 10/975,931

(22) Filed: Oct. 29, 2004

(30) Foreign Application Priority Data
Oct. 31, 2003 (JP) 2003-372641

(51) Int. Cl. C09K 19/00

(52) U.S. Cl. 428/1.3

(57) ABSTRACT

An optical compensatory sheet comprises a cellulose acylate film. The optical compensatory sheet can also comprises a transparent support and an optically anisotropic layer formed from a liquid crystal compound. The optical compensatory sheet is characterized in that the retardation value in plane measured at the temperature of 20° C. under the relative humidity of 20% is in the range of 97 to 103% based on the retardation value in plane measured at the temperature of 10° C. under the relative humidity of 20%.

### FIELD OF THE INVENTION

The present invention relates to an optical compensatory sheet comprising a cellulose acylate film. The invention also relates to an optical compensatory sheet comprising an optically anisotropic layer formed from a liquid crystal compound. The invention further relates to a liquid crystal display comprising the optical compensatory sheet.

### BACKGROUND OF THE INVENTION

A widely used optical film comprises aligned and fixed liquid crystal molecules. The film has recently been used as an optical compensatory sheet in a liquid crystal display, a brightness-improving film or an optical compensatory sheet in a display device of projector type. The optical film has been remarkably developed particularly as an optical compensatory sheet in a liquid crystal display.

A liquid crystal display generally comprises a polarizing plate and a liquid crystal cell. The most widely used display is a TFT liquid crystal display of TN mode, in which an optical compensatory sheet is provided between the polarizing plate and the liquid crystal cell. The compensatory sheet enables the display to give images of high quality, but often makes it thick and heavy. It is, therefore, very hard to take advantage of thinness of the liquid crystal display.

The polarizing plate generally comprises two protective films and a polarizing membrane provided between them. In order to improve front contrast without thickening the display, it is proposed (for example, in Japanese Patent provisional Publication No. 1(1989)-68940) to use a polarizing plate (elliptically polarizing plate) in which either of the protective films is replaced with an optical compensatory sheet. However, the optical compensatory sheet provided in the elliptically polarizing plate often so less improves viewing angle that the display gives an image of poor quality.

For solving the problem of viewing angle without thickening the display, it is proposed (for example, in Japanese Patent Provisional Publication No. 7(1995)-191217 and European Patent No. 0911656) to use a polarizing plate (elliptically polarizing plate) in which either of the protective films is replaced with an optical compensatory sheet comprising a transparent support and an optically anisotropic layer formed from liquid crystal molecules (e.g., discotic liquid crystal molecules).

Recently, the liquid crystal display of TN mode has been increasingly used in a TV set. In view of performance as a screen of TV set, it is important to display moving images. However, it is pointed out that moving images given by the liquid crystal display of TN mode are affected by how rapidly the display responds (i.e., by response time). For example, moving images given by the display often tail away.

In view of this, it is proposed (for example, in Japanese Patent Provisional Publication Nos. 9(1997)-211444 and 11(1999)-316378) to use a liquid crystal display of OCB mode in place of the display of TN mode. According to the publications, the liquid crystal display of OCB mode equipped with an optical compensatory sheet comprising a transparent support and an optically anisotropic layer formed from liquid crystal molecules works rapidly enough to display moving images and solves the problem of viewing angle. However, since portable enough to carry by a car or to use outdoors, a liquid crystal display TV is always required to keep displaying images of high quality even under severe conditions such as high temperature, low temperature, high humidity and low humidity.

In order to display images of high quality at a high temperature, it is proposed (for example, in Japanese Patent Provisional Publication No. 8(1996)-278406) to make the optically anisotropic film (optical compensatory sheet) change retardation according as the liquid crystal cell thermally changes the retardation. However, there is no proposal to keep image quality at a low temperature or to provide a liquid crystal display of OCB mode capable of working rapidly at a low temperature.

### SUMMERY OF THE INVENTION

It is an object of the present invention to solve the problem in displaying a moving image (particularly, to improve response time) when a liquid crystal display works at a low temperature.

It is another object of the invention to solve various problems arising when a liquid crystal display is used in a portable TV set. The invention aims to solve these problems without increasing the thickness of the display.

It is further object of the invention to provide an optical compensatory sheet suitable for a liquid crystal display of OCB mode and capable of improving quality of displayed images.

The present invention provides an optical compensatory sheet comprising a cellulose acylate film, wherein the retardation value in plane measured at the temperature of 20° C. under the relative humidity of 20% is in the range of 97 to 103% based on the retardation value in plane measured at the temperature of 10° C. under the relative humidity of 20%.

The invention also provides a liquid crystal display comprising a liquid crystal cell provided between two polarizing plates, polarizing plate, wherein the liquid crystal display further comprises an optical compensatory sheet between the liquid crystal cell and the polarizing plate, said optical compensatory sheet comprising a cellulose acylate film, and wherein the retardation value in plane measured at the temperature of 20° C. under the relative humidity of 20% is in the range of 97 to 103% based on the retardation value in plane measured at the temperature of 10° C. under the relative humidity of 20%.

The invention further provides a liquid crystal display comprising a reflection board, a liquid crystal cell and a polarizing plate in order, wherein the liquid crystal display further comprises an optical compensatory sheet between the liquid crystal cell and the polarizing plate, said optical compensatory sheet comprising a cellulose acylate film, and wherein the retardation value in plane measured at the temperature of 20° C. under the relative humidity of 20% is in the range of 97 to 103% based on the retardation value in plane measured at the temperature of 10° C. under the relative humidity of 20%.

The invention furthermore provides an optical compensatory sheet comprising a transparent support and an optically anisotropic layer formed from a liquid crystal compound, wherein the retardation value in plane measured at the temperature of 20° C. under the relative humidity of 20% is in the range of 97 to 103% based on the retardation value in plane measured at the temperature of 10° C. under the relative humidity of 20%.

The invention still further provides a liquid crystal display comprising a liquid crystal cell provided between two polarizing plates, polarizing plate, wherein the liquid crystal display further comprises an optical compensatory sheet between the liquid crystal cell and the polarizing plate, said optical compensatory sheet comprising a transparent support and an optically anisotropic layer formed from a liquid crystal compound, and wherein the retardation value in plane measured at the temperature of 20° C. under the relative humidity of 20% is in the range of 97 to 103% based on the retardation value in plane measured at the temperature of 10° C. under the relative humidity of 20%.

The invention still furthermore provides a liquid crystal display comprising a reflection board, a liquid crystal cell and a polarizing plate in order, wherein the liquid crystal display further comprises an optical compensatory sheet between the liquid crystal cell and the polarizing plate, said optical compensatory sheet comprising a cellulose acylate film, and wherein the retardation value in plane measured at the temperature of 20° C. under the relative humidity of 20% is in the range of 97 to 103% based on the retardation value in plane measured at the temperature of 10° C. under the relative humidity of 20%.

The retardation value in plane (Re) is defined by the following formula:
Re=(nx−ny)×d
in which nx is a refractive index along the slow axis in the film plane (in the direction giving the maximum refractive index), ny is a refractive index along the fast axis in the film plane (in the direction giving the minimum refractive index), and d is the thickness (nm) of the film.

In the present specification, the wavelength at which the retardation value in plane is measured is 590 nm except that it is particularly defined.

The slow axis of the optically anisotropic layer is normally parallel or perpendicular to the direction obtained by projecting the line of molecular symmetry onto the support.

The response time of liquid crystal display is measured at the temperature of 20° C. under the relative humidity of 20%. Even if measured under the conditions of 10° C. and 20% RH, the response time is preferably 300 ms or less.

The applicant's study reveals that the liquid crystal cell shows a retardation value remarkably less dependent upon temperature under cold condition. Accordingly, the retardation value of optical compensatory sheet preferably less changes under cold condition. The “optical compensatory sheet” means not only a sheet canceling out the phase difference of liquid crystal cell (namely, a sheet optically compensating the liquid crystal cell) but also an optically isotropic sheet controlling hues of color images that a liquid crystal display gives according to the phase difference.

The optical compensatory sheet of the invention comprises a cellulose acylate film or an optically anisotropic layer formed from a liquid crystal compound. Water affects both the cellulose acylate film and the optically anisotropic layer, to make their retardation thermally dependent particularly under cold condition. If contained in the cellulose acylate film or the optically anisotropic layer, water disturbs alignment of the cellulose acylate molecules or liquid crystal compound-derived molecules constituting the film or layer and, as a result, lowers their retardation. The amount of water contained in the film or layer generally decreases under cold condition, and accordingly the retardation increases at a low temperature.

The present invention prevents the retardation of optical compensatory sheet from changing, and thereby improves characters (particularly, response time) of liquid crystal display in displaying moving images at a low temperature.

### BRIEF DESCRIPTION OF THE DRAWING

FIG. 1 is a sectional view schematically showing a structure of a liquid crystal display of OCB mode.

### DETAILED DESCRIPTION OF THE INVENTION

[Basic Structure of Liquid Crystal Display]

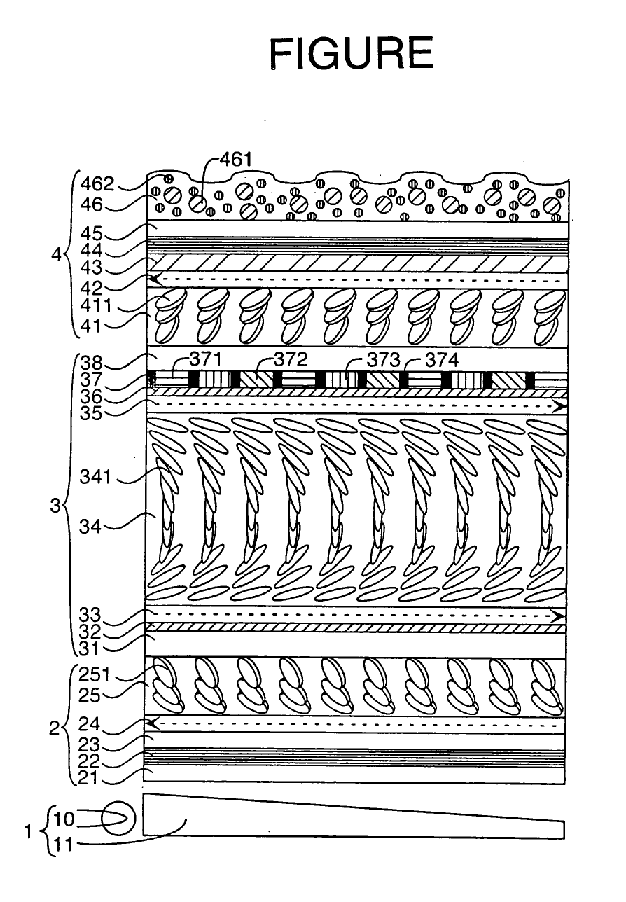

FIG. 1 is a sectional view schematically showing a structure of a liquid crystal display of OCB mode.

The liquid crystal display shown in FIG. 1 comprises a backlight unit (1), a backlight-side polarizing plate (2), a liquid crystal cell of bend alignment mode (3) and a viewer-side polarizing plate (4).

The backlight unit (1) comprises a light source (11) and a light-guide plate (12). A diffusing plate or a film for increasing brightness may be provided between the backlight unit (1) and the backlight-side polarizing plate (2).

The backlight-side polarizing plate (2) comprises a second transparent protective film (21), a polarizing membrane (22), a first transparent protective film comprising a cellulose acylate film (23), an orientation layer (24) and an optically anisotropic layer (25) formed from liquid crystal compound, layered in this order. The first transparent protective film (23) may have optical anisotropy. In FIG. 1, the arrow in the orientation layer (24) indicates a rubbing direction. In the optically anisotropic layer (25), molecules of the discotic liquid crystal compound (251) are oriented in hybrid alignment, in which the liquid crystal molecules near the orientation layer (24) are aligned at small inclined angles while those far from the orientation layer (24) are at large inclined angles.

The optical compensatory sheet according to the present invention can be used as the first transparent protective film comprising a cellulose acylate film (23), or a combination of a first transparent protective film (23), an orientation layer (24) and an optically anisotropic layer (25) formed from liquid crystal compound.

The liquid crystal cell of a bend alignment mode (3) comprises a lower glass substrate (31), a lower transparent electro-conductive membrane (32), a lower orientation layer (33), a liquid crystal layer (34), an upper orientation layer (35), an upper transparent electro-conductive membrane (36), a color filter (37) and an upper glass substrate (38), layered in this order. In FIG. 1, the arrows in the orientation layers (33, 35) indicate rubbing directions. In the liquid crystal layer (34), molecules of the rod-like liquid crystal compound (341) are oriented in bend alignment, in which the upper and lower molecules are symmetrically aligned. The color filter (37) comprises blue parts (371), green parts (372), red parts (373) and black matrixes (374) among the parts.

The viewer-side polarizing plate (4) comprises an optically anisotropic layer (41) formed from liquid crystal compound, an orientation layer (42), a first transparent protective film comprising a cellulose acylate film (43), a polarizing membrane (44), a second transparent protective film (45) and a light-diffusing layer (46), layered in this order. In the optically anisotropic layer (41), molecules of the discotic liquid crystal compound (411) are oriented in hybrid alignment, in which the liquid crystal molecules near the orientation layer (42) are aligned at small inclined angles while those far from the orientation layer (42) are at large inclined angles. In FIG. 1, the arrow in the orientation layer (42) indicates a rubbing direction. The first transparent protective film (43) has optical anisotropy, and the second transparent protective film (45) may have optical isotropy.

The optical compensatory sheet according to the present invention can be used as the first transparent protective film comprising a cellulose acylate film (43), or a combination of a first transparent protective film (43), an orientation layer (42) and an optically anisotropic layer (41) formed from liquid crystal compound.

The light-diffusing layer (46) comprises transparent resin, therein-dispersed first transparent fine particles (461) and second ones (462). The first and second transparent fine particles preferably have different refractive indexes and different sizes (namely, the total size distribution curve preferably has two peaks). They may be the same kind of particles (they may have the same refractive index) but have different sizes, or otherwise they may have almost the same sizes (namely, the size distribution curve need not have clearly separated peaks) but have different refractive indexes. It is also possible to use only one kind of particles. On the light-diffusing layer (46), a low-refractive index layer may be provided.

[Optical Characters of Optical Compensatory Sheet]

The optical compensatory sheet of the invention is characterized in that the retardation value in plane measured at the temperature of 20° C. under the relative humidity of 20% is in the range of 97 to 103% (preferably, 98 to 102%) based on that measured at the temperature of 10° C. under the relative humidity of 20%. In other words, the retardation values in plane Re20 and Re10 measured at 20° C. under 20% RH and at 10° C. under 20% RH, respectively, satisfy the condition of: 0.97×Re10≦Re20≦1.03×Re10.

[Cellulose Acylate Film (Transparent Support)]

The optical compensatory sheet of the invention comprises a cellulose acylate film or a transparent support. Here, the term “transparent” means that light transmittance is not less than 80%. The transparent support preferably comprises a polymer film. Examples of the polymer include cellulose esters (e.g., cellulose acetate, cellulose diacetate), norbornene-based polymers and poly(meth)acrylic esters (e.g., polymethacrylate). Commercially available polymers such as Artone and Zeonex (norbornene-based polymer) may be used.

In addition, films of polymers that often show birefringence (e.g., polycarbonate, polysulfone) are also usable as a less birefringent transparent support if modified (in the manner described in WO00/26705) so as not to show the birefringence.

Cellulose esters are preferably used as the polymer, and cellulose acylate is particularly preferred. Accordingly, the optical compensatory sheet of the invention preferably comprises at least one cellulose acylate film as a constituting element.

As the cellulose acylate, cellulose esters of lower fatty acids are preferred. The term “lower fatty acids” means fatty acids having 6 or less carbon atoms. The number of carbon atoms is preferably 2 (cellulose acetate), 3 (cellulose propionate) or 4 (cellulose butyrate). Cellulose esters of mixed fatty acids such as cellulose acetate propionate and cellulose acetate butyrate are also usable. Cellulose acetate is particularly preferred.

In the case where the optical compensatory sheet is used as the protective film or the phase retarder of the polarizing plate, the cellulose acetate preferably has acetic acid content of 55.0 to 62.5%. The acetic acid content is more preferably in the range of 57.0 to 62.0%. The term “acetic acid content” means the amount of combined acetic acid per one weight unit of cellulose. The acetic acid content is determined according to ASTM: D-817-91 (tests of cellulose acetate).

The cellulose acetate has a viscosity average polymerization degree (DP) of preferably 250 or more, more preferably 290 or more. Further, it is also preferred for the cellulose acetate to have a narrow molecular weight distribution of Mw/Mn (Mw and Mn are weight and number average molecular weights, respectively) determined by gel permeation chromatography. The value of Mw/Mn is preferably in the range of 1.0 to 1.7, more preferably in the range of 1.00 to 1.65, most preferably in the range of 1.0 to 1.6.

In a cellulose acetate, hydroxyl groups at 2-, 3- and 6-positions are not equally substituted, and the substitution degree at 6-position is apt to be relatively small. However, in the cellulose acetate used as the polymer film in the invention, the substitution degree at 6-position is preferably not smaller than those at 2- and 3-positions. The substitution degree at 6-position is preferably 30% to 40%, more preferably 31% to 40%, most preferably 32% to 40%, based on the total substitution degree at 2-, 3- and 6-positions. Further, the substitution degree at 6-position is preferably 0.88 or more. The substitution degree at each position can be measured by means of NMR.

A cellulose acetate having a high substitution degree at 6-position can be prepared according to the methods described in Japanese Patent Provisional Publication No. 11(1999)-5851.

The retardation value in plane of the transparent support is preferably in the range of 0 to 200 nm, more preferably in the range of 20 to 150 nm, most preferably in the range of 30 to 100 nm. The retardation value along the thickness of the transparent support is preferably in the range of 40 to 400 nm. In the case where two optical compensatory sheets are installed in a liquid crystal display, the retardation values in plane and along the thickness are preferably in the ranges of 40 to 250 nm and 150 to 400 nm, respectively.

The retardation values in plane (Re) and along the thickness (Rth) are defined by the following formulas.
Re=(nx−ny)×d
Rth={(nx+ny)/2−nz}×d

In the formulas, nx is a refractive index along the slow axis in the plane (in the direction giving the maximum refractive index), ny is a refractive index along the fast axis in the plane (in the direction giving the minimum refractive index), nz is a refractive index along the thickness, and d is the thickness (nm).

Cellulose acylate having an acyl group of 2 to 4 carbon atoms (which is described in Japanese Patent Provisional Publication Nos. 2002-210766, 2002-187958) is also preferably used.

The transparent support has a birefringence in plane (Δn: nx−ny) preferably in the range of 0.00025 to 0.00088. The birefringence along the thickness ((nx+ny)/2−nz) is preferably in the range of 0.00088 to 0.005.

The variation of the retardation in plane (Re) of the cellulose acylate film (in more detail, variation according to change of water content at a low temperature) can be minimized by adding a hydrophobic compound having a molecular weight in the range of 200 to 700 and 2 or less oxygen atoms in an amount of 4 to 15 wt. % based on the amount of cellulose acylate. The hydrophobic compound preferably has one or no oxygen atom. The amount of the hydrophobic compound is preferably 4 to 10 wt. %, and more preferably 4 to 7 wt. %5 based on the amount of cellulose acylate.

Some of retardation-increasing agents can be hydrophobic compounds satisfying the above-mentioned conditions. The retardation-increasing agent is an additive for a cellulose acylate film. The retardation-increasing agent has a function of increasing a retardation value along a thickness direction (Rth) of the cellulose acylate film. The retardation-increasing agents (including hydrophilic compounds as well as hydrophobic compounds) are described in Japanese Patent Provisional Publication Nos. 2000-111914 and 2000-154261.

In the present invention, the hydrophilic compound is used to minimize the variation of the retardation value in plane (Re), not to increase the retardation value along the thickness direction (Rth). Due to the difference in use of the compound, the hydrophobic compound is used in a relatively large amount (4 to 15 wt. % based on the amount of cellulose acylate) compared with the amount of the retardation-increasing agent (1.5 wt. % or 3 wt. %).

The hydrophobic compound preferably has 1,3,5-triazine ring.

The hydrophobic 1,3,5-triazine compound is preferably represented by the formula (I). The hydrophobic compound of the formula (I) scarcely separates out (bleeds out) on the surface of the cellulose acylate film. Accordingly, a large amount of the compound can be added into the film to minimize the variation of the retardation value in plane (Re).

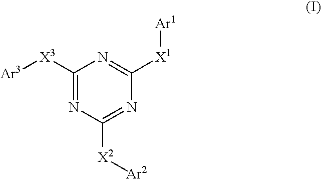

In the formula (I), each of Ar¹, Ar² and Ar³ independently is an aromatic hydrocarbon group or an aromatic heterocyclic group (e.g., pyridyl). The aromatic hydrocarbon group is preferred to the aromatic heterocyclic group.

The aromatic hydrocarbon group means an aryl group or a substituted aryl group. The aromatic hydrocarbon group preferably is phenyl or a substituted phenyl group. The substituted phenyl group preferably has a substituent group at 3-, 4- or 5-position.

Examples of the substituent groups of the substituted aryl groups include a halogen atom, cyano, nitro, an alkyl group, an alkenyl group, an aryl group, an alkoxy group, an alkenyloxy group, an aryloxy group, an acyl group, an alkylcarbamoyl group, an alkenylcarbamoyl group, an arylcarbamoyl group, an alkylsulfamoyl group, an alkenylsulfamoyl group, an arylsulfamoyl group, an amido group, an alkylthio group, an alkenylthio group and arylthio group.

In the formula (I), each of X¹, X² and X³ independently is a single bond or —NR—. R is hydrogen or an alkyl group having 1 to 6 carbon atoms. —NR— is preferred to the single bond. —NH— is most preferred.

Examples of the hydrophobic compounds are shown below. 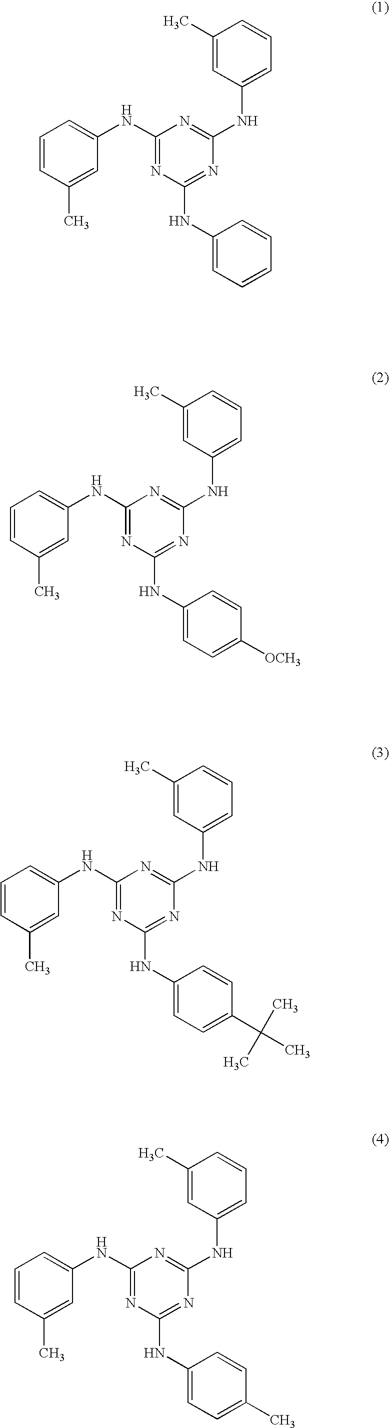 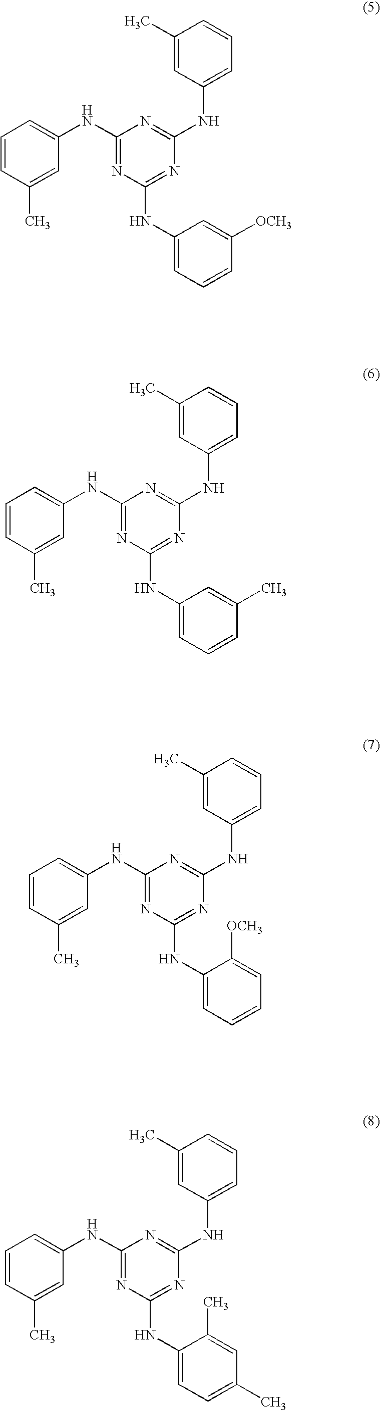 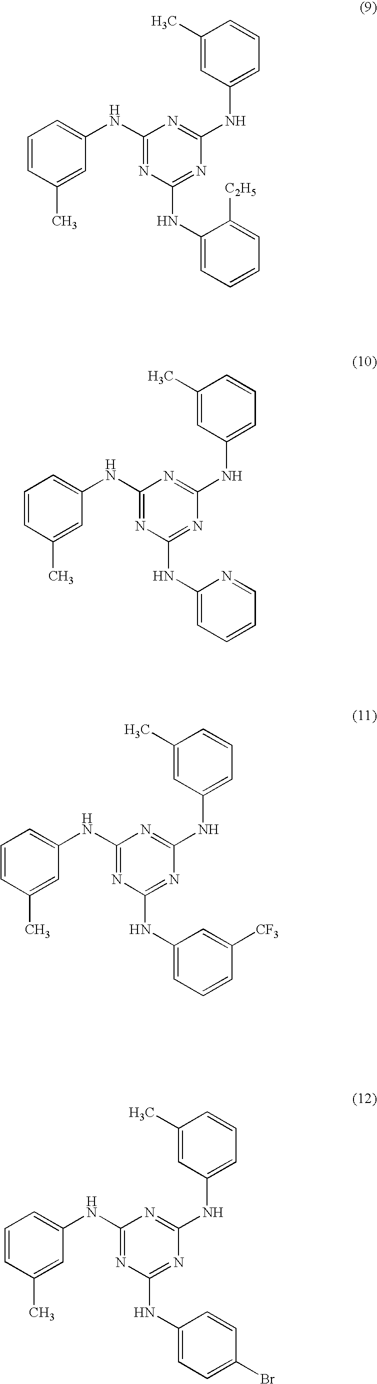 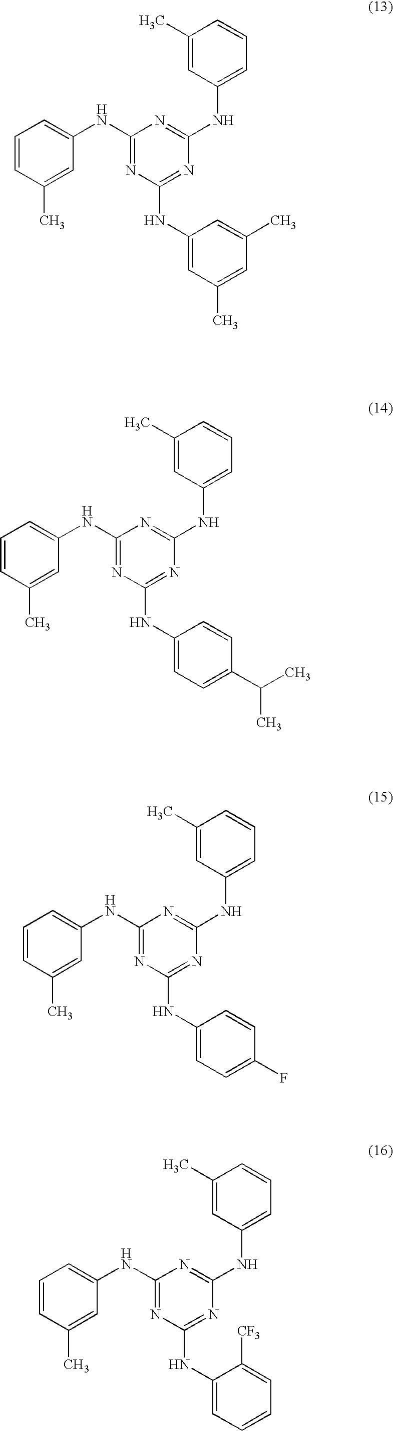 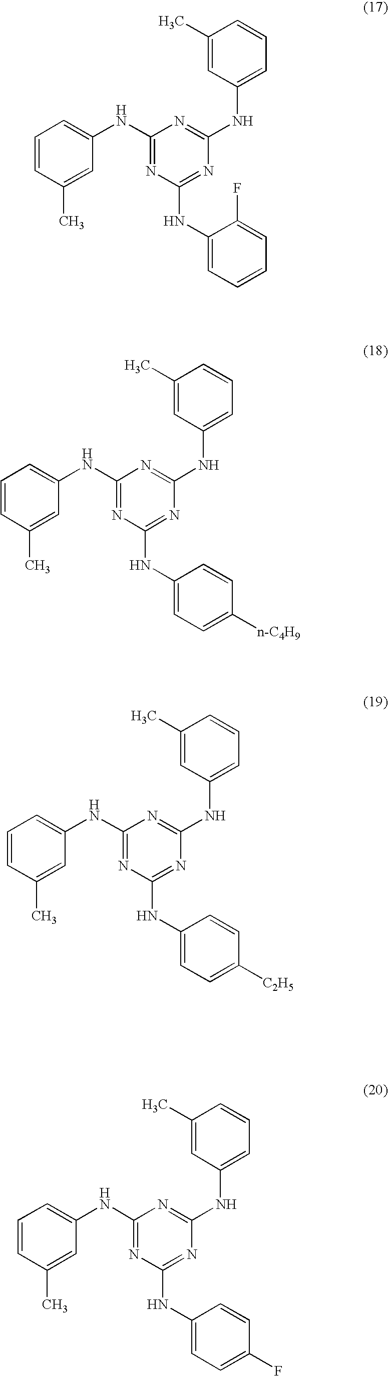 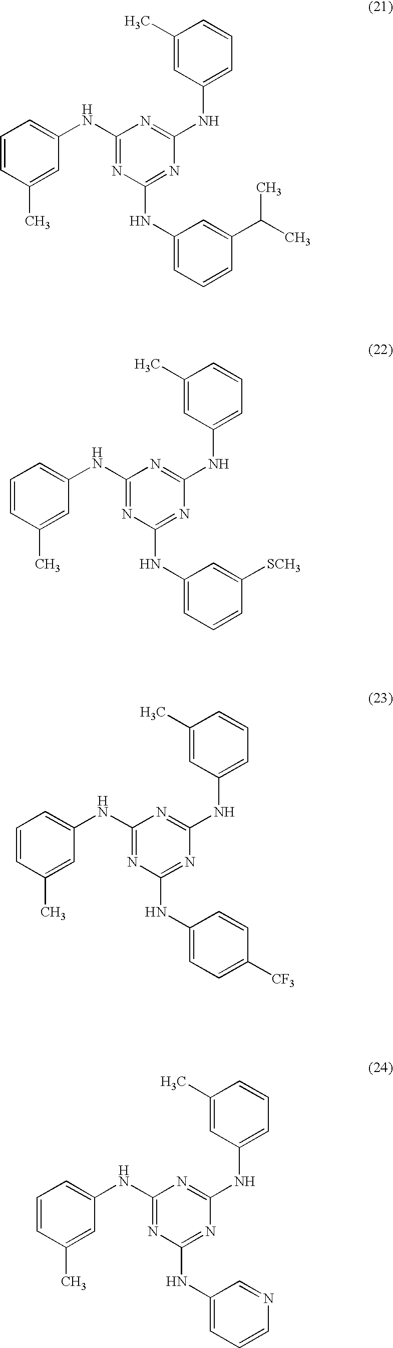 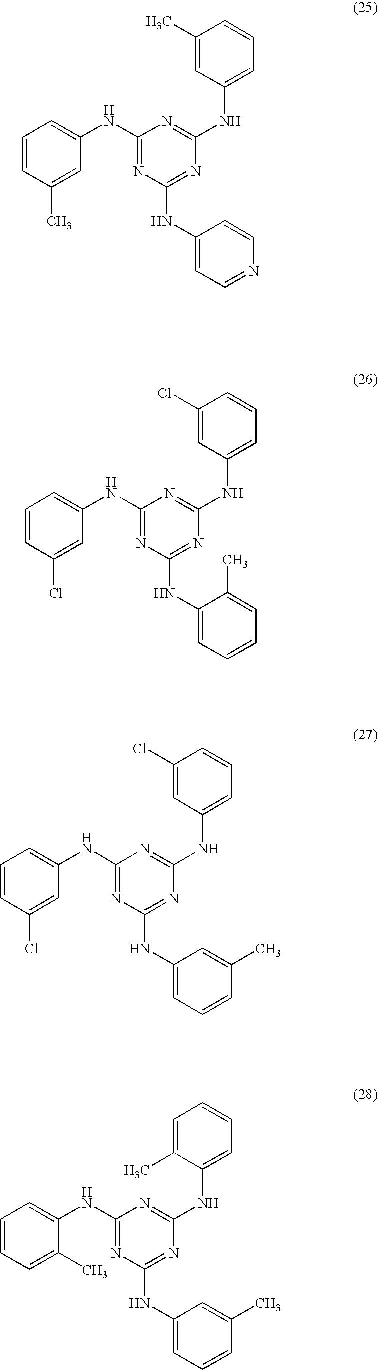 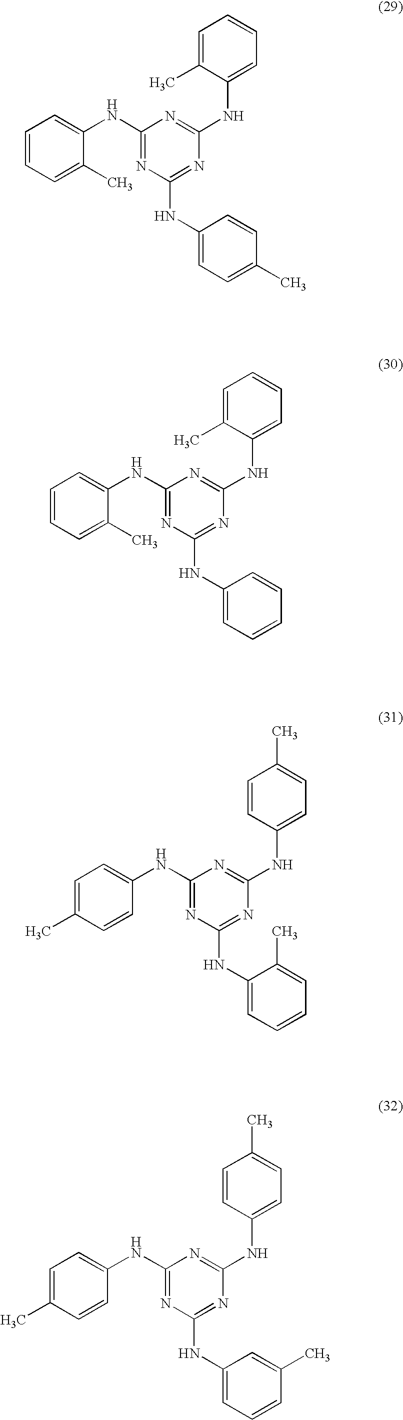 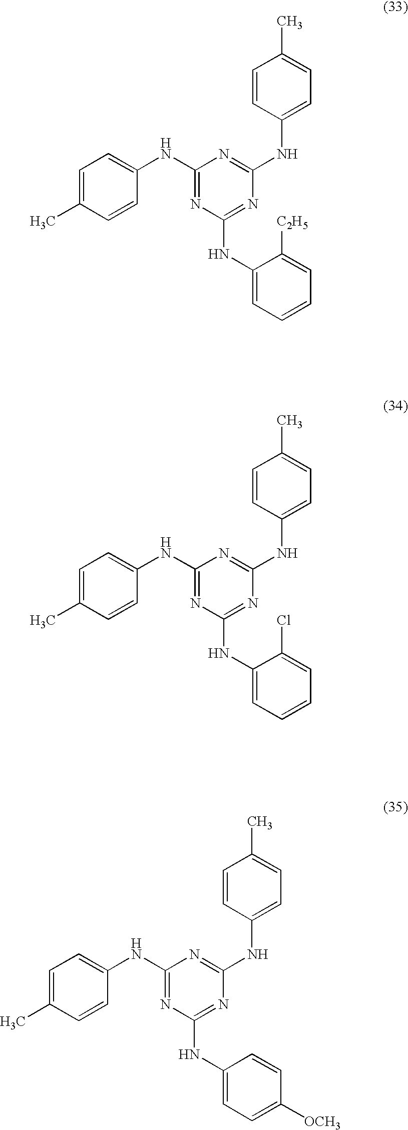 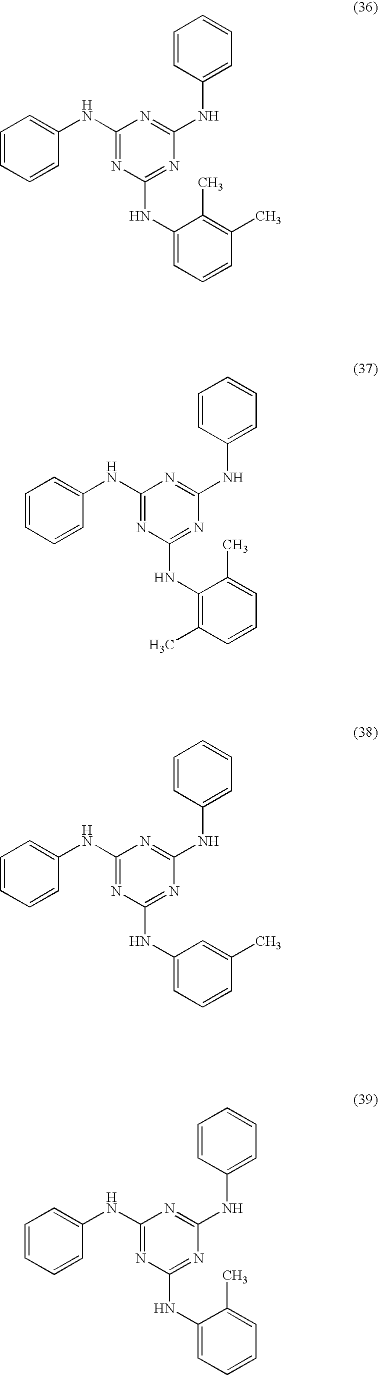 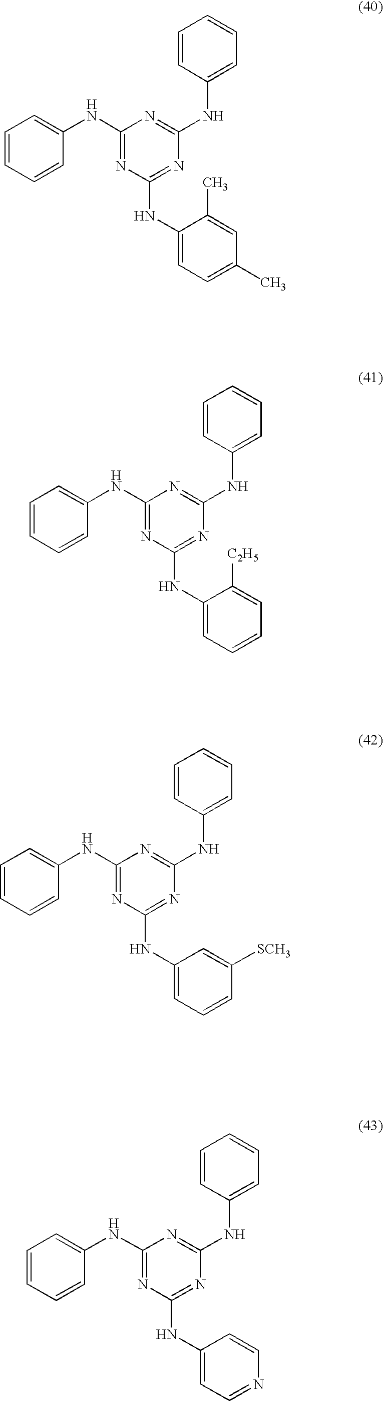 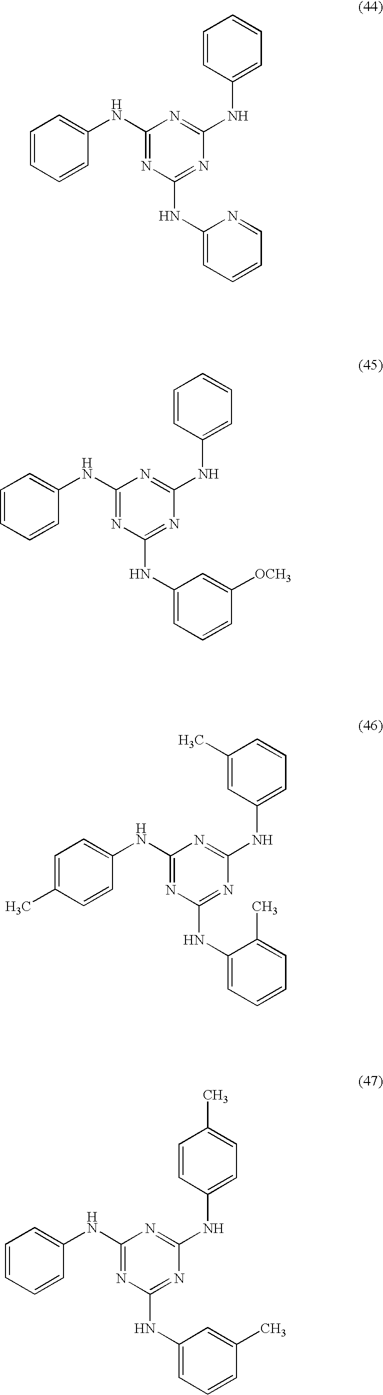 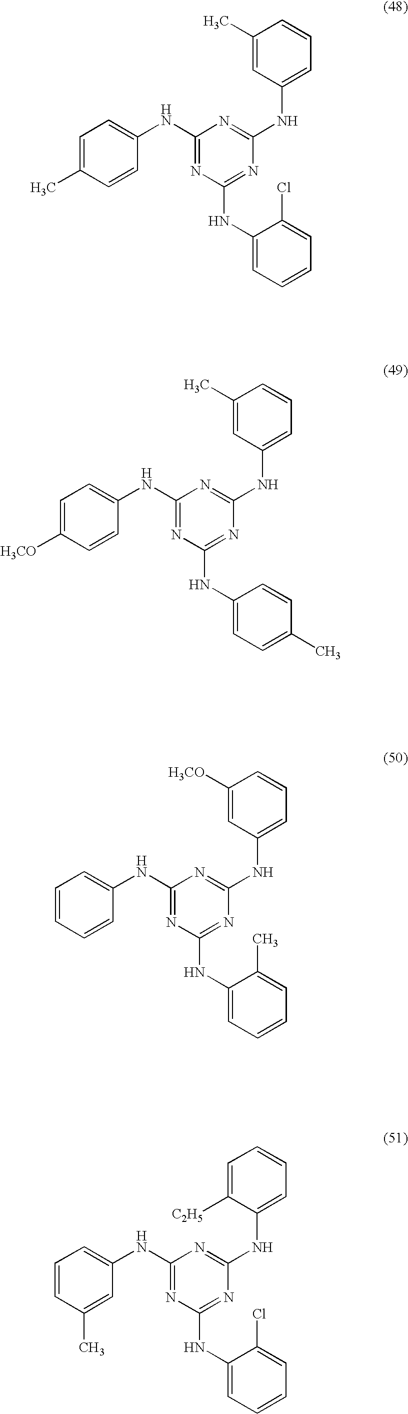 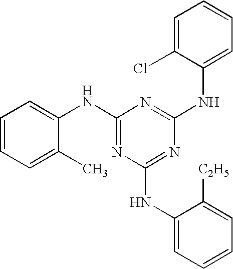
[Optically Anisotropic Layer]

The optically anisotropic layer is formed from a liquid crystal compound. The anisotropic layer can be directly formed on the surface of the transparent support, or otherwise can be formed on an orientation layer beforehand provided on the transparent support. Further, after formed on a temporary substrate from the liquid crystal compound, the anisotropic layer may be transferred onto the support to produce the optical compensatory sheet. In that case, an adhesive layer may be beforehand provided on the support.

The liquid crystal compound is preferably a rod-like or discotic compound, which may be a polymer liquid crystal. Further, a polymer in which liquid crystal molecules are cross-linked and hence which no longer behaves as liquid crystal is also usable.

Examples of the rod-like liquid crystal compound include azomethines, azoxys, cyanobiphenyls, cyanophenyl esters, benzoic esters, phenyl esters of cyclohexanecarboxylates, cyanophenylcyclohexanes, cyano-substituted phenylpyrimidines, alkoxy-substituted phenylpyrimidines, phenyldioxanes, tolans, and alkenylcyclohexylbenzonitriles. Metal complexes are also included in the rod-like liquid crystal compounds. Further, a liquid crystal polymer in which the repeating unit comprises a rod-like liquid crystal moiety is also usable. In other words, the rod-like liquid crystal compound may be combined with polymer to form a liquid crystal polymer.

Descriptions of the rod-like liquid crystal compounds are found in “Kagaku-Sosetsu, Ekisho no Kageku” (written in Japanese), vol. 22(1994), Chapters 4, 7 and 11; and “Ekisho Devise Handbook” (written in Japanese), Chapter 3.

The rod-like liquid crystal molecule preferably has a birefringence of 0.001 to 0.7.

The rod-like liquid crystal molecule preferably has a polymerizable group to fix the alignment. The polymerizable group preferably is an unsaturated polymerizable group or an epoxy group, more preferably is an unsaturated polymerizable group, and most preferably is an ethylenically unsaturated group.

Examples of the discotic liquid crystal compound include benzene derivatives described in C. Destrade et al., Mol. Cryst. vol. 71, pp. 111, (1981); truxene derivatives described in C. Destrade et al., Mol Cryst. vol. 122, pp. 141. (1985), Physics lett. A, vol. 78, pp. 82, (1990); cyclohexane derivatives described in B. Kohn et al., Angew. Chem. vol. 96, pp. 70, (1984); and macrocyclic compounds of azacrown-type or phenylacetylene-type described in J. M. Lehn et al., J. Chem. Commun. pp. 1794, (1985), and J. Zhang et al., J. Am. Chem. Soc. vol. 116, pp. 2655, (1994).

The discotic liquid crystal compound generally has a structure in which a parent core is located at the center and side chains (straight chain groups such as alkyl, alkoxy and substituted benzoyloxy) are radially substituted around the parent core. The compound is preferably such a rotationally symmetrical molecule or aggregate thereof capable of making proper orientation.

Even if the optically anisotropic layer is formed from discotic liquid crystal molecules, it is not necessary for the compound contained in the resultant layer to behave as liquid crystal. For example, in forming the layer, a low molecular-weight discotic liquid crystal compound having a thermo- or photo-reactive group is polymerized by heat or light to form a polymer that does not behave as liquid crystal. Such polymer can be also used in the invention. When a discotic liquid crystal compound is polymerized, the formed polymer normally no longer behaves as liquid crystal. Preferred examples of the discotic liquid crystal compound are described in Japanese Patent Provisional Publication No. 8(1996)-50206. Japanese Patent Provisional Publication No. 8(1996)-27284 describes polymerization of the discotic liquid crystal compound.

A polymerizable group should be bound to a discotic core of the discotic compound, so as to cause the polymerization reaction of the compound and to fix the molecules. However, if the polymerizable group is directly bound to the discotic core, it is difficult to keep the alignment at the polymerization reaction. Therefore, a linking group is introduced between the discotic core and the polymerizable group. Accordingly, the discotic compound having a polymerizable group is preferably represented by the formula:
D(-L-Q)ₙ
in which D is a discotic core; L is a divalent linking group; Q is a polymerizable group; and n is an integer of 4 to 12.

Examples of the discotic cores (D) are shown below. In the following examples, LQ (or QL) means the combination of the divalent linking group (L) and the polymerizable group (Q).

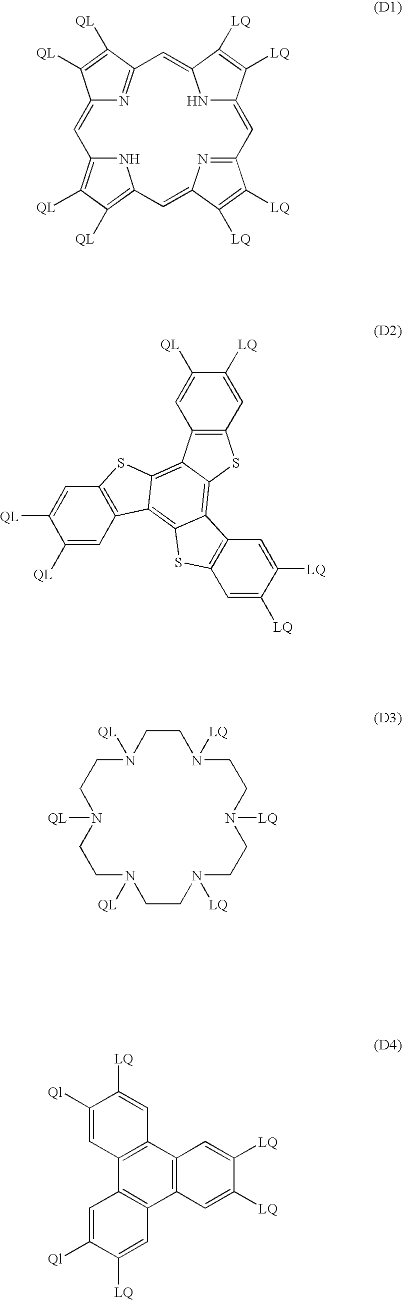

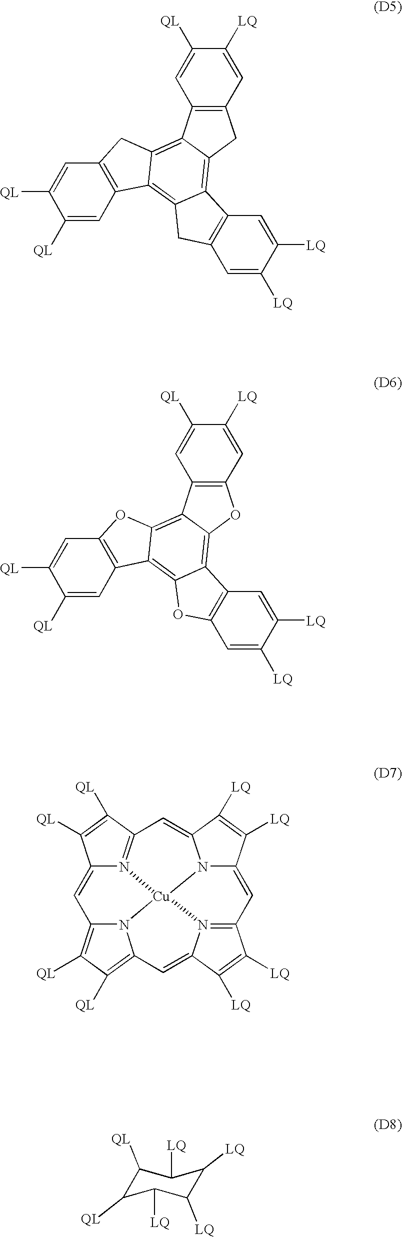

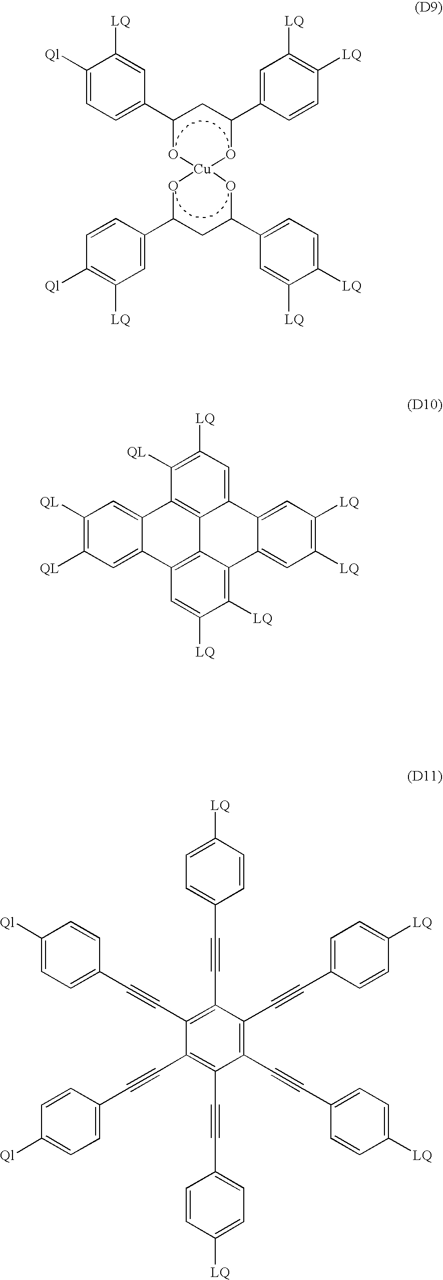

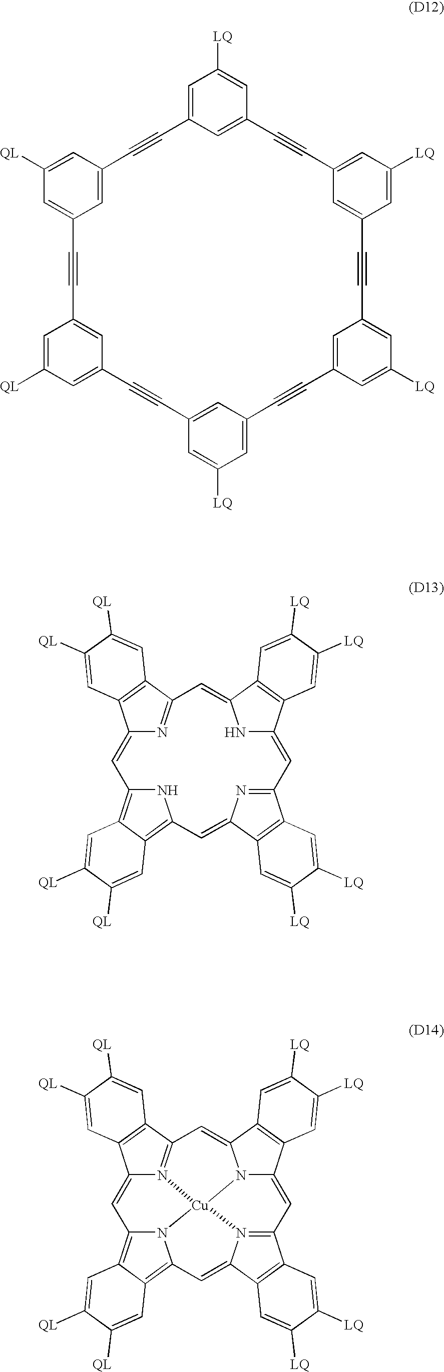

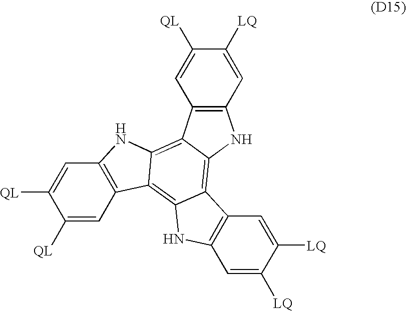

In the above formula, the divalent linking group (L) preferably is selected from the group consisting of an alkylene group, an alkenylene group, an arylene group, —CO, —NH—, —O—, —S— and combinations thereof. L more preferably is a combination of at least two divalent groups selected from the group consisting of an alkylene group, an arylene group, —CO—, —NH—, —O— and —S—. L most preferably is a combination of at least two divalent groups selected from the group consisting of an alkylene group, an arylene group, —CO— and —O—. The alkylene group preferably has 1 to 12 carbon atoms. The alkenylene group preferably has 2 to 12 carbon atoms. The arylene group preferably has 6 to 10 carbon atoms.

Examples of the divalent linking groups (L) are shown below. In the following examples, the left side is attached to the discotic core (D), and the right side is attached to the polymerizable group (Q). The AL means an alkylene group or an alkenylene group. The AR means an arylene group. The alkylene group, the alkenylene group and the arylene group may have a substituent group (e.g., an alkyl group).
L1: -AL-CO—O-AL-
L2: -AL-CO—O-AL-O-
L3: -AL-CO—O-AL-O-AL-
L4: -AL-CO—O-AL-O—CO-
L5: —CO-AR-O-AL-
L6: —CO-AR-O-AL-O-
L7: —CO-AR-O-AL-O—CO-
L8: —CO—NH-AL-
L9: —NH-AL-O-
L10: —NH-AL-O—CO-
L11: —O-AL-
L12: —O-AL-O-
L13: —O-AL-O—CO-
L14: —O-AL-O—CO—NH-AL-
L15: —O-AL-S-AL-
L16: —O—CO-AR-O-AL-CO-
L17: —O—CO-AR-O-AL-O—CO-
L18: —O—CO-AR-O-AL-O-AL-O—CO-
L19: —O—CO-AR-O-AL-O-AL-O-AL-O—CO-
L20: —S-AL-
L21: —S-AL-O-
L22: —S-AL-O—CO-
L23: —S-AL-S-AL-
L24: —S-AR-AL-

The polymerizable group (Q) in the above formula is determined according to the polymerization reaction. The polymerizable group (Q) preferably is an unsaturated polymerizable group or an epoxy group, more preferably is an unsaturated polymerizable group, and most preferably is an ethylenically unsaturated group.

In the above formula, n is an integer of 4 to 12, which is determined according to the chemical structure of the discotic core (D). The 4 to 12 combinations of L and Q can be different from each other. However, the combinations are preferably identical.

The molecules of liquid crystal compound are preferably aligned so that the lines of molecular symmetry in the optically anisotropic layer may be at an angle of 43° to 47° on average to the longitudinal direction.

If oriented in hybrid alignment, the liquid crystal molecules have lines of molecular symmetry inclined from the surface of the support. The inclined angle depends on how deeply the molecule is positioned in the optically anisotropic layer. The angle increases or decreases according as the distance from the surface of the support increases in the direction of the depth of the anisotropic layer. Preferably, the angle preferably decreases with increase of the distance. The inclined angle may change in the manner of continuous increase, continuous decrease, intermittent increase, intermittent decrease, hybrid variation comprising continuous increase and decrease or intermittent variation comprising increase or decrease. In the case where the inclined angle changes in the manner of the intermittent variation, there is a range in which the angle does not change in the course of the thickness direction of the anisotropic layer.

As long as the angle totally increases or decreases, there may be a range in which the angle does not change. The angle, however, preferably changes continuously.

The average direction of the lines of molecular symmetry can be generally controlled by selecting the liquid crystal compound or material of the orientation layer, or by selecting a method of the rubbing treatment.

In producing an optical compensatory sheet in which the slow axis of transparent support is neither parallel nor perpendicular to that of the optically anisotropic layer, the optically anisotropic layer may be subjected to the rubbing treatment in a direction other than the slow axis of support.

With respect to the molecules positioned on the surface (air) side, the average direction of the lines of molecular symmetry can be also generally controlled by selecting the liquid crystal compound or additives used together with the liquid crystal compound. Examples of the additives include plasticizer, surface-active agent, polymerizable monomer and polymer. Further, how much the orientation direction of the lines of molecular symmetry varies can be also controlled in the same manner as described above. The surface-active agent is preferably used to control the surface tension of the coating solution.

The plasticizer, the surface-active agent and the polymerizable monomer used together with the liquid crystal compound are preferably compatible with the discotic liquid crystal compound, and they preferably give variation of the inclined angle or do not prevent the discotic liquid crystal molecules from aligning. Polymerizable monomers (e.g., compounds having vinyl, vinyloxy, acryloyl or methacryloyl group) are preferred. Those compounds are added generally in an amount of 1 to 50 wt. %, preferably in an amount of 5 to 30 wt. % based on the amount of the liquid crystal compound. If a monomer having 4 or more polymerizable functional groups is mixed to use, the adhesion between the orientation layer and the optically anisotropic layer is enhanced.

In order to prevent the retardation of the optical compensatory sheet from changing (namely, to prevent the water content from changing at a low temperature), a compound having many polymerizable functional groups is preferably used as the liquid crystal compound or as the polymerizable monomer so that the optically anisotropic layer may be three-dimensionally cross-linked.

In the case where a discotic liquid crystal compound is used as the liquid crystal compound, a polymer compatible with the discotic compound and capable of giving variation of the inclined angle is preferably added to the optically anisotropic layer.

The polymer is preferably cellulose ester or cellulose ether. Cellulose ester is more preferred. Examples of the cellulose ester include cellulose acetate, cellulose acetatepropionate, and cellulose acetatebutylate. Examples of the cellulose ether include hydroxypropylcellulose. In order not to prevent the discotic liquid crystal molecules from aligning, the amount of the polymer is preferably in the range of 0.1 to 10 wt. %, more preferably in the range of 0.1 to 8 wt. %, most preferably in the range of 0.1 to 5 wt. % based on the amount of the discotic liquid crystal compound.

The transition temperature from discotic nematic phase to solid phase of the discotic liquid crystal compound is preferably in the range of 70 to 300° C., more preferably 70 to 170° C.

The thickness of the optically anisotropic layer is preferably in the range of 0.1 to 20 μm, more preferably in the range of 0.5 to 15 μm, most preferably in the range of 1 to 10 μm.

[Orientation Layer]

An orientation layer is preferably provided between the transparent support and the optically anisotropic layer.

The orientation layer is preferably a membrane of cross-linked polymer. As the polymer, cross-linkable polymers can be used. For example, polymers having functional groups can be cross-linked by light, heat or pH variation to form the orientation layer. The polymers may be cross-linked with cross-linking agents. In that case, highly reactive cross-linking agents may be used to introduce linking groups into the polymers, so as to form the orientation layer.

For forming an orientation layer made of cross-linked polymer, a coating solution containing a cross-linkable polymer or a mixture of polymer and a cross-linking agent is spread to coat the transparent support, and then the cross-linking reaction is induced by light, heat or pH variation.

The degree of cross-linking is preferably increased so that dust produced in the rubbing treatment may be reduced. The degree of cross-linking is defined by the formula:
1−(Ma/Mb)
in which Ma is the amount of cross-linking agent remaining after the cross-linking reaction; and Mb is the amount of cross-linking agent added before the reaction. The degree of cross-linking is preferably in the range of 50 to 100%, more preferably in the range of 65 to 100%, most preferably in the range of 75 to 100%.

Examples of the polymers used for the orientation layer include polymethyl methacrylate, polyacrylic acid, polymethacrylic acid, polystyrene, polymaleinimide, polyvinyl alcohol, denatured polyvinyl alcohol, poly(N-methylolacrylamide), polyvinyltoluene, chlorosulfonated polyethylene, nitrocellulose, polyvinyl chloride, chlorinated polyolefin, polyester, polyimide, polyvinyl acetate, polyethylene, carboxymethylcellulose, gelatin, polypropylene, polycarbonate and copolymers thereof (e.g., acrylic acid/methacrylic acid copolymer, styrene/maleinimide copolymer, styrene/vinyltoluene copolymer, vinyl acetate/vinyl chloride copolymer, and ethylene/vinyl acetate copolymer). Silane coupling agents may be used. Preferred examples are water-soluble polymers such as poly(N-methylolacrylamide), carboxymethylcellulose, gelatin, polyvinyl alcohol and denatured polyvinyl alcohol. Gelatin, polyvinyl alcohol and denatured polyvinyl alcohol are more preferred, and polyvinyl alcohol and denatured polyvinyl alcohol are particularly preferred.

The saponification degree of the polyvinyl alcohol is in the range of preferably 70 to 100%, more preferably 80 to 100%, more preferably 85 to 95%. The polymerization degree is preferably in the range of 100 to 3,000.

The denatured polyvinyl alcohol may be a polyvinyl alcohol denatured by copolymerization, by chain transfer or by block polymerization. Examples of denaturing groups introduced by copolymerization include —COONa, —Si(OX)₃ (in which X is hydrogen or an alkyl group), —N(CH₃)₃.Cl, —C₉H₁₉, —COO, —SO₃Na and —C₁₂H₂₅. Examples of denaturing groups introduced by chain transfer include —COONa, —SH and —C₁₂H₂₅. Examples of denaturing groups introduced by block polymerization include —COOH, —CONH₂, —COOR (in which R is an alkyl group) and —C₆H₅. An alkylthio group is also one of the preferred denaturing groups.

The denatured polyvinyl alcohol is described in Japanese Patent Provisional Publication No. 8(1996)-338913.

In the case where a hydrophilic polymer such as polyvinyl alcohol is used in the orientation layer, the content of water is preferably controlled in consideration of hardness of the layer. The content of water is preferably in the range of 0.4 to 2.5%, more preferably in the range of 0.6 to 1.6%. The content of water can be measured by means of a commercially available apparatus accordingly to Karl Fischer's method.

The thickness of the orientation layer is preferably 10 μm or less.

[Production of Optical Compensatory Sheet]

The optical compensatory sheet is generally produced in the form of a roll. For producing the rolled optical compensatory sheet, it is preferred to conduct successively the following steps (1) to (4).

(1) While a belt-shaped transparent support is being transferred in the longitudinal direction; the surface of the support or the surface of an orientation layer formed on the support is subjected to the rubbing treatment with a rubbing roller.

(2) The surface subjected to the rubbing treatment is coated with a coating solution containing the liquid crystal compound.

(3) After or while the coating solution on the surface is dried, molecules of the liquid crystal compound are aligned at a temperature higher than the transition temperature to liquid crystal phase. The alignment is then fixed to form an optically anisotropic layer.

(4) The formed belt-shaped laminate in which the optically anisotropic layer is formed on the support is wound up into a roll.

In the above step (3), while the liquid crystal molecules are aligned at a temperature higher than the transition temperature, air is made to flow just above the coating solution spread on the surface. The stream of air blows in the direction other than the rubbing direction at the speed V preferably satisfying the condition of:
0<V<5.0×10⁻³×η
in which V is a speed of air flow (m/second) and η is a viscosity (cp) of the optically anisotropic layer at the temperature for aligning the liquid crystal molecules.

The speed V is more preferably in the range of 0 to 2.5×10⁻³×η.

The steps (1) to (4) make it possible to produce continuously and stably an optical compensatory sheet in which the average direction obtained by projecting onto the support the lines of molecular symmetry of the liquid crystal molecules (average direction of the lines of molecular symmetry in the optically anisotropic layer) is not parallel to the slow axis in plane of the transparent support (longitudinal direction of the support) and in which the lines of molecular symmetry are oriented on average at an angle of −2° to 2°, preferably −1° to 1°, more preferably essentially 0°, to the rubbing direction. The process of the steps (1) to (4) is, namely, suitable for mass production.

In the case where the optical compensatory sheet is installed in a liquid crystal display of OCB mode, the lines of molecular symmetry are preferably oriented on average at an angle of essentially 45° to the slow axis in plane of the transparent support (longitudinal direction of the support).

In the step (2), a polymerizable liquid crystal compound having cross-linkable functional group may be used as the liquid crystal compound. In that case, the spread coating solution is continuously exposed to light in the step (3) so that the molecules of polymerizable liquid crystal compound may be polymerized to fix the alignment, and successively the step (4) is conducted.

In the step (1), the rubbing treatment with a rubbing roller may be conducted while dust on the support or on the orientation layer is removed.

The procedure for removing the dust on the rubbed support or on the rubbed orientation layer may be conducted before the step (2).

Prior to the step (4), optical characters of the formed optically anisotropic layer may be continuously measured to test the quality of the layer.

The steps (1) to (4) are described in Japanese Patent Provisional Publication No. 9(1997)-73081.

The rubbing roller used in the step (1) has a diameter of preferably 100 mm to 500 mm, more preferably 200 mm to 400 mm, in consideration of handling and durability of rubbing cloth. The roller must be wider than the transferred support, and is preferably 2^{1/2} or more times as wide as the support. The rotation speed of the roller is preferably set low enough to reduce dust, and is determined according to the alignment of liquid crystal molecules. The roller rotates preferably at a rate of 100 to 1,000 rpm, more preferably at a rate of 250 to 850 rpm.

Even if the rotation speed is set at a low rate, the support or the orientation layer is preferably heated during the rubbing treatment to keep the alignment. The heating is preferably conducted so that the temperature on the surface of the support or orientation layer (surface temperature) may be in the range of (glass transition temperature of the material −50° C.) to (glass transition temperature of the material +50° C.). In the case where an orientation layer of polyvinyl alcohol is used, the rubbing treatment is preferably conducted with the humidity controlled. The relative humidity at 25° C. is preferably in the range of 25 to 70%, more preferably in the range of 30 to 60%, most preferably in the range of 35 to 55%.

The transparent support is transferred at a speed of preferably 10 to 100 m/second, more preferably 15 to 80 m/second, in consideration of productivity and alignment. Various known apparatuses can be used for transferring the support, and there is no particular restriction on the transferring method.

For forming the orientation layer, a coating solution containing material such as polyvinyl alcohol dissolved in water or an organic solvent is applied and dried on the transparent support. The orientation layer may be formed before the aforementioned steps, or otherwise may be continuously formed on the transferred belt-shaped transparent support.

In the step (2), a coating solution containing the liquid crystal compound is spread to coat the surface subjected to the rubbing treatment. A solvent for preparation of the coating solution preferably is an organic solvent. Examples of the organic solvents include amides (e.g., N,N-dimethylformamide), sulfoxides (e.g., dimethylsulfoxide), heterocyclic compounds (e.g., pyridine), hydrocarbons (e.g., benzene, hexane), alkyl halides (e.g., chloroform, dichloromethane, tetrachloroethane), esters (e.g., methyl acetate, butyl acetate), ketones (e.g., acetone, methyl ethyl ketone) and ethers (e.g., tetrahydrofuran, 1,2-dimethoxyethane). Alkyl halides and ketones are preferred. Two or more organic solvents can be used in combination.

The coating solution has a surface tension of preferably 25 mN/m or less, more preferably 22 mN/m or less, so as to form a highly homogeneous optically anisotropic layer. In order to make the surface tension low enough, a surface-active agent is preferably added to the coating solution. The surface-active agent is preferably a fluorine-containing surface-active agent, more preferably a surface-active agent of fluorine-containing polymer, most preferably surface-active agent of fluoroaliphatic group-containing polymer. The fluorine-containing polymer may be a copolymer comprising a fluorine-containing repeating unit and other repeating units (e.g., repeating unit derived from polyoxyalkylene(meth)acrylate).

The weight average molecular weight of the fluorine-containing polymer is preferably in the range of 3,000 to 100,000, more preferably in the range of 6,000 to 80,000. The content of the fluorine-containing polymer is preferably in the range of 0.005 to 8 wt. %, more preferably in the range of 0.01 to 1 wt. %, most preferably in the range of 0.05 to 0.5 wt. %, based on the weight of the coating composition (components of the coating solution except the solvent), which mainly comprises the liquid crystal compound.

The coating solution is spread to coat the rubbed surface according to a conventional coating method (such as a wire-bar coating method, an extrusion coating method, a direct gravure coating method, a reverse gravure coating method or a die coating method). How much the coating solution is spread is optionally determined according to the thickness of the optically anisotropic layer.

In the step (3), after or while the coating solution on the surface is dried, molecules of the liquid crystal compound are aligned at a temperature higher than the transition temperature to liquid crystal phase. The alignment is then fixed to form an optically anisotropic layer. Heat given after or during the drying procedure orients the molecules in a desired alignment. The temperature for drying can be determined according to the boiling point of the solvent used in the coating solution and according to materials of the support and the orientation layer. The temperature for aligning the liquid crystal molecules can be determined according to the transition temperature of liquid crystal compound between liquid crystal phase-solid phase. If a discotic liquid crystal compound is used, the temperature for aligning is preferably in the range of 70 to 300° C., more preferably in the range of 70 to 170° C.

The liquid crystal compound in liquid crystal phase has a viscosity of preferably 10 to 10,000 cp, more preferably 100 to 1,000 cp. If the viscosity is too low, the alignment of liquid crystal molecules is often affected by flowing air. Accordingly, in that case, it is necessary to control direction and/or velocity of the flowing air precisely in producing the sheet continuously. On the other hand, if the viscosity is too high, it takes so much time to align the molecules that the productivity is very impaired, although the flowing air does not affect the alignment.

The viscosity depends on the molecular structure of liquid crystal compound, and hence the liquid crystal compound is selected in consideration of the viscosity. It is also possible to control the viscosity by incorporating a proper amount of additive (e.g., cellulose polymer) or gelationizer.

In the heating procedure, air heated at a predetermined temperature is blown or the sheet is transferred through a heating chamber in which the temperature is kept at the predetermined temperature.

The aligned liquid crystal molecules can be fixed with the alignment maintained to from the optically anisotropic layer. The molecules may be cooled to a temperature lower than the transition temperature to solid phase, and thereby fixed. Otherwise, they may be polymerized to fix. The liquid crystal molecules are fixed preferably by a polymerization reaction. The polymerization reaction can be classified into a thermal reaction induced by a thermal polymerization initiator and a photoreaction induced by a photo polymerization initiator. A photo polymerization reaction is preferred.

Examples of the photo polymerization initiators include α-carbonyl compounds (described in U.S. Pat. Nos. 2,367,661, 2,367,670), acyloin ethers (described in U.S. Pat. No. 2,448,828), α-hydrocarbon substituted aromatic acyloin compounds (described in U.S. Pat. No. 2,722,512), polycyclic quinone compounds (described in U.S. Pat. Nos. 2,951,758, 3,046,127), combinations of triarylimidazoles and p-aminophenyl ketones (described in U.S. Pat. No. 3,549,367), acridine or phenazine compounds (described in Japanese Patent Provisional Publication No. 60(1985)-105667 and U.S. Pat. No. 4,239,850) and oxadiazole compounds (described in U.S. Pat. No. 4,212,970).

The amount of the photo polymerization initiator is preferably in the range of 0.01 to 20 wt. %, and more preferably in the range of 0.5 to 5 wt. % based on the solid content of the coating solution.

The light irradiation for the photo polymerization is preferably conducted with ultraviolet rays. The exposure energy is preferably in the range of 20 to 50,000 mJ/cm², more preferably in the range of 20 to 5,000 mJ/cm², most preferably in the range of 100 to 800 mJ/cm². The light irradiation can be conducted while the layer is heated to accelerate the photo polymerization reaction. For exposing to the light, the transparent support coated with the coating solution for forming the optically anisotropic layer may be transferred through an exposing zone in which a light source is provided above, under or beside the conveying path.

Before the step (4), a protective film may be provided on the optically anisotropic layer formed in the step (3). For example, a protective film beforehand prepared may be continuously laminated on the belt-shaped optically anisotropic layer.

In the step (4), a belt-shaped laminate comprising the formed optically anisotropic layer is wound up. For example, the support coated with the optically anisotropic layer is continuously conveyed and wound up around a cylindrical core.

The optical compensatory sheet produced in the step (4) is in the form of a roll, and hence can be easily handled or treated even if mass-produced. In fact, it is easy to store or convey the rolls of optical compensatory sheet.

[Polarizing Plate]

The optical compensatory sheet and a polarizing membrane are laminated to prepare a polarizing plate (elliptically polarizing plate). For example, the optical compensatory sheet in the form of a roll is cut into strips of desired sizes, and then laminated on the polarizing membrane. Otherwise, after the optical compensatory sheet in the form of a roll is laminated on the polarizing membrane in the shape of long belt, the formed laminate may be cut into strips of desired sizes.

The polarizing plate prepared by laminating the optical compensatory sheet and the polarizing membrane has not only polarizing function but also optical compensating function, and is hence advantageously installed in a liquid crystal display. If the optical compensatory sheet is used as a protective film of the polarizing membrane, the liquid crystal display can be made thin.

Examples of the polarizing membrane include films of orientation type and of coating type (available from Optiva Inc). The film of orientation type comprises a binder and either iodine or a dichromatic dye. Iodine or the dichromatic dye in the polarizing membrane causes polarizing function when the molecules thereof are oriented. They are preferably oriented along the binder molecules, or otherwise the molecules of dichromatic dye preferably automatically organize to be oriented in a certain direction like liquid crystal molecules do.

A commercially available polarizing membrane is generally produced by immersing a stretched polymer film in a bath of iodine or dichromatic dye solution so that the iodine or dichromatic dye may penetrate into the binder. In a commercially available polarizing membrane, the iodine or dichromatic dye is distributed in a range within the depth of approx. 4 μm from each of the top and bottom surfaces (the total thickness of the range is approx. 8 μm). However, in order to obtain sufficient polarizability, the range where the iodine or dichromatic dye is distributed is required to have at least 10 μm thickness in total. How deeply the iodine or dichromatic dye penetrates can be controlled by adjusting the concentration of iodine or dichromatic dye solution, the temperature of bath and/or the time for immersing.

The polarizing membrane is preferably not thicker than a commercially available polarizing membrane (having a thickness of approx. 30 μm). The thickness is more preferably 25 μm or less, further preferably 20 μm or less. The polarizing membrane having a thickness of 20 μm or less prevents a liquid crystal display of 17 inches from leaking light.

The binder of the polarizing membrane may be cross-linked. A polymer cross-linkable by itself can be used as the binder. Further, a polymer which originally has functional groups or to which functional groups are introduced can be reacted with light, heat or pH variation to form the polarizing membrane. Otherwise, the polymer may be cross-linked with a cross-linking agent. In detail, bonding groups given by the highly reactive cross-linking agent can be introduced to cross-link the binder of the polarizing membrane.

In a normal process, a coating solution containing the cross-linkable polymer or a mixture of polymer and the cross-linking agent is spread to coat a transparent support, and then heated to induce the cross-linking reaction. The reaction may be caused at any stage from the first step of spreading the coating solution to the final step of producing the resultant membrane, so long as the resultant membrane has sufficient durability.

Polymers cross-linkable either by itself or with cross-linking agents can be used. Examples of the polymers include polymethyl methacrylate, polyacrylic acid, polymethacrylic acid, polystyrene, polyvinyl alcohol, denatured polyvinyl alcohol, poly(N-methylolacrylamide), polyvinyl toluene, chlorosulfonate polyethylene, nitrocellulose, chlorinated polyolefin (polyvinyl chloride), polyester, polyimide, polyvinyl acetate, polyethylene, carboxymethyl cellulose, polypropylene, polycarbonate, and copolymers thereof (e.g., acrylic acid/methacrylic acid copolymer, styrene/maleinimide copolymer, styrene/vinyltoluene copolymer, vinyl acetate/vinyl chloride copolymer, ethylene/vinyl acetate copolymer). Silane-coupling agents are also usable as the polymer. Preferred are water-soluble polymers (e.g., poly(N-methylolacrylamide), carboxymethylcellulose, gelatin, polyvinyl alcohol and denatured polyvinyl alcohol). Gelatin, polyvinyl alcohol and denatured polyvinyl alcohol are particularly preferred, and polyvinyl alcohol and denatured polyvinyl alcohol are most preferred.

The saponification degree of the polyvinyl alcohol or denatured polyvinyl alcohol is in the range of 70 to 100%, preferably in the range of 80 to 100%, more preferably in the range of 95 to 100%. The polymerization degree of the polyvinyl alcohol is preferably in the range of 100 to 5,000.

The denatured polyvinyl alcohol may be a polyvinyl alcohol denatured by copolymerization, by chain transfer or by block polymerization. Examples of denaturing groups introduced by copolymerization include —COONa, —Si(OX)₃ (in which X is hydrogen or an alkyl group), —N(CH₃)₃.Cl, —C₉H₁₉, —COO, —SO₃Na and —C₁₂H₂₅. Examples of denaturing groups introduced by chain transfer include —COONa, —SH and —SC₁₂H₂₅. The polymerization degree of the denatured polyvinyl alcohol is preferably in the range of 100 to 3,000. The denatured polyvinyl alcohol is described in Japanese Patent provisional Publication Nos. 8(1996)-338913, 9(1997)-152509 and 9(1997)-316127.

Non-denatured or alkylthio-denatured polyvinyl alcohols having saponification degrees of 85 to 95% are particularly preferred.

Two or more non-denatured and denatured polyvinyl alcohols may be used in combination.

The cross-linking agent is described in U.S. Republished Pat. No. 23,297. Boron compounds (e.g., boric acid, borax) are also usable as the cross-linking agent.

The more the cross-linking agent is added to the binder, the more the durability of polarizing membrane against moisture and heat is improved. However, if the amount of cross-linking agent is 50 wt. % or more based on the amount of the binder, the molecules of iodine or dichromatic dye are poorly aligned. Accordingly, the amount of cross-linking agent is preferably in the range of 0.1 to 20 wt. %, more preferably in the range of 0.5 to 15 wt. % based on the amount of the binder. Even after the cross-linking reaction is completed, the binder contains non-reacted cross-linking agent a little. The amount of the non-reacted cross-linking agent remaining in the binder is preferably not more than 1.0 wt. %, more preferably not more than 0.5 wt. % based on the amount of the binder. If the binder contains the non-reacted agent in an amount of more than 1.0 wt. %, the membrane often has poor durability. If the polarizing membrane containing a considerable amount of remaining cross-linking agent is installed in a liquid crystal display and used for a long time or left under hot and humid condition, the polarizability is often lowered.

Examples of the dichromatic dye include azo dyes, stilbene dyes, pyrazolone dyes, triphenyl methane dyes, quinoline dyes, oxazine dyes, thiazine dyes, and anthraquinone dyes. Water-soluble dyes are preferred. The dichromatic dye preferably has a hydrophilic group (e.g., sulfo, amino, hydroxyl). Examples of the dichromatic dye further include C.I. direct yellow 12, C.I. direct orange 39, C.I. direct orange 72, C.I. direct red 39, C.I. direct red 79, C.I. direct red 81, C.I. direct red 83, C.I. direct red 89, C.I. direct violet 48, C.I. direct blue 67, C.I. direct blue 90, C.I. direct green 59 and C.I. direct acid red 37. Japanese Patent Provisional Publication Nos. 1(1989)-161202, 1(1989)-172906, 1(1989)-172907, 1(1989)-183602, 1(1989)-248105, 1(1989)-265205 and 7(1995)-261024 describe the dichromatic dye.

The dichromatic dye is used in the form of a free acid or a salt (alkali metal salt, ammonium salt, amine salt). Two or more dichromatic dyes may be used in combination, to produce polarizing membranes having various hues. The dichromatic dye enables a polarizing membrane to show a desired hue. For example, a dichromatic dye or a mixture of various dichromatic dyes showing black hue when polarizing axes are perpendicularly crossed is preferred. The polarizing membrane comprising such dichromatic dye or mixture is excellent in both polarizability and transmittance when singly used.

[Production of Polarizing Plate]

The binder is preferably stretched in the longitudinal (MD) direction of the membrane (stretching method). Otherwise, the binder is preferably dyed with iodine or dichromatic dye after subjected to rubbing treatment (rubbing method).

In stretching the binder, the stretching ratio is preferably in the range of 2.5 to 30.0, more preferably in the range of 3.0 to 10.0. The stretching can be carried out either in air (dry stretching) or in water (wet stretching). The stretching ratio in dry stretching is preferably in the range of 2.5 to 5.0 while that in wet stretching is preferably in the range of 3.0 to 10.0. The stretching may be carried out several times, and if so the binder can be uniformly stretched even at a high stretching ratio. Before the stretching, the binder may be beforehand laterally or longitudinally stretched slightly (so that the lateral shrinkage may be prevented).

In consideration of production yield of the polarizing membrane, the binder is preferably stretched in a direction inclined at 10 to 80° to the longitudinal direction. In that case, the binder can be biaxially stretched. In the biaxial stretching, the binder is stretched rightward and leftward in different steps. The biaxial stretching can be carried out in the normal manner conventionally adopted in forming a known film. The rightward and leftward stretching speeds in the biaxial stretching are different from each other, and accordingly before the stretching it is necessary to form the binder film so that the thickness at the right side of the film and that at the left side are different from each other. For example, in forming the film by casting a binder solution, a die equipped with a taper can be used so that the amount of the solution cast on the right side and that on the left side may be different from each other.

The angle of the inclined direction for stretching (inclined angle) preferably corresponds to the angle between the longitudinal or lateral direction of liquid crystal cell and the transmission axes of two polarizing plates laminated on both sides of the cell in the liquid crystal display. The inclined angle is normally 45°, but is not always 45° in a recently developed liquid crystal display of transmission type, reflection type or semi-transmission type. The stretching direction is, hence, preferably adjusted according to the liquid crystal display.

Thus, a binder film stretched obliquely at 10° to 80° to the MD direction of the polarizing membrane can be produced.

The rubbing treatment can be conducted in the manner adopted widely in aligning liquid crystal molecules of liquid crystal display. The surface of the film is rubbed with paper, cloth (gauze, felt, nylon, polyester) or rubber along a certain direction, to give the aligning function. Generally, the film is rubbed several times with cloth on which fibers having the same length and thickness are provided. It is preferred to use a rubbing roller whose out of roundness, out of cylindricalness and eccentricity are all 30 μm or less. The lapping angle of the film onto the rubbing roller is preferably in the range of 0.1 to 90°. As described in Japanese Patent Provisional Publication No. 8(1996)-160430, the lapping angle may be 360° or more (namely, the film may be wound around the roll) to perform the rubbing treatment stably.

In the case where a long film is subjected to the rubbing treatment, the film is preferably transferred with a constant tension at a speed of 1 to 100 m/minute. The rubbing roller preferably rotates so horizontally to the transferring direction and so freely that the rubbing angle can be desirably set up. The rubbing angle is preferably in the range of 0° to 60°. For the liquid crystal display, the rubbing angle is preferably in the range of 40° to 50°, particularly 45°.

On both surfaces of polarizing membrane, protective films are preferably provided. As one of the films, a part of the rolled optical compensatory sheet is preferably used. Preferably, the resultant laminate comprises protective film/polarizing membrane/transparent support/optically anisotropic layer, or otherwise protective film/polarizing membrane/transparent support/orientation layer/optically anisotropic layer, layered in this order. The polarizing membrane may be laminated on the surface-side of the optically anisotropic layer. The polarizing membrane and the optically anisotropic layer, or otherwise the polarizing membrane and the orientation layer can be laminated with adhesive. Examples of the adhesive include polyvinyl alcohol resins (e.g., polyvinyl alcohols denatured with acetoacetyl group, sulfonic group, carboxyl group or oxyalkylene group) and aqueous solutions of boron compounds. Polyvinyl alcohol resins are preferred.

A layer of the adhesive has a dry thickness of preferably 0.01 to 10 μm, more preferably 0.05 to 5 μm.

If the polarizing plate is installed in a liquid crystal display, an anti-reflection layer is preferably provided on the viewer-side surface. The anti-reflection layer may serve as the protective film on the viewer side. The anti-reflection layer preferably has an internal haze of 50% or more, so as to prevent hues of displayed images from depending upon the viewing angle. The anti-reflection layer is described in Japanese Patent Provisional Publication Nos. 2001-33783, 2001-343646 and 2002-328228.

Both transmittance and polarizability of the polarizing plate are preferably as high as possible, so as to increase the contrast ratio of liquid crystal display. The transmittance at 550 nm is preferably in the range of 30 to 50%, more preferably in the range of 35 to 50%, most preferably in the range of 40 to 50%. The polarizability at 550 nm is preferably in the range of 90 to 100%, more preferably in the range of 95 to 100%, most preferably in the range of 99 to 100%.

[Liquid Crystal Display]

The optical compensatory sheet or a polarizing plate equipped with the compensatory sheet is preferably used in a liquid crystal display of birefringent mode. The optical compensatory sheet of the invention is advantageously used in a liquid crystal display responding rapidly at a low temperature, particularly, a display of OCB mode. The response time of the display is preferably 10 ms or shorter at room temperature. The response time at 0° C. is preferably 200 ms or shorter, more preferably 100 ms or shorter. The response time at −20° C. is preferably 500 ms or shorter, more preferably 300 ms or shorter. The “response time” means time it takes to change the displaying tone, for example, from a black tone to a white tone, or from a medium tone to another medium tone.

A liquid crystal display of transmission type comprises a liquid crystal cell and two polarizing plates placed on both sides of the cell. The liquid crystal cell comprises a pair of electrode substrates and liquid crystal molecules provided between them.

The optical compensatory sheet is provided between the cell and either or each of the polarizing plates.

A liquid crystal cell of OCB mode is a liquid crystal cell of bend alignment mode in which rod-like liquid crystal molecules in upper part and ones in lower part are essentially reversely (symmetrically) aligned. A liquid crystal display having the liquid crystal cell of bend alignment mode is disclosed in U.S. Pat. Nos. 4,583,825 and 5,410,422. Since rod-like liquid crystal molecules in upper part and ones in lower part are symmetrically aligned, the liquid crystal cell of bend alignment mode has self-optical compensatory function. Therefore, this mode is referred to as OCB (optically compensatory bend) mode. The liquid crystal display of OCB mode has the advantage of quick response.

### EXAMPLE 1

(Preparation of Transparent Support)

The following components were poured into a mixing tank, and stirred and heated to dissolve each component. Thus, a cellulose acetate solution was prepared.

Cellulose acetate solution

| | | |
|---|---|---|
| Cellulose acetate (acetic acid content: 60.9%) | 100 | weight parts |
| Triphenyl phosphate (plasticizer) | 7.8 | weight parts |
| Biphenyldiphenyl phosphate (plasticizer) | 3.9 | weight parts |
| Methylene chloride (first solvent) | 300 | weight parts |
| Methanol (second solvent) | 45 | weight parts |
| Dye (360FP, Sumika Fine Chemicals Co., Ltd.) | 0.0009 | weight part |

Independently, 16 weight parts of the hydrophobic compound (2), 80 weight parts of methylene chloride and 20 weight parts of methanol were poured into another mixing tank, and stirred and heated to prepare a hydrophobic compound solution.

The cellulose acetate solution (464 weight parts), the hydrophobic compound solution (36 weight parts) and 1.1 weight parts of silica fine particles (Aerosil R972) were mixed and stirred well to prepare a dope. The prepared dope contained the retardation-increasing agent and the silica fine particles in the amounts of 5.0 weight parts and 0.15 weight part, respectively, based on 100 weight parts of cellulose acetate.

The dope was cast on a band by means of a band-casting machine (width: 2 m, length: 65 m). After the surface temperature of the dope on the band reached 40° C., the dope was dried for 1 minute. After peeled from the band, the film was laterally stretched by 28% by means of a tenter while exposed to flowing air at 140° C. The stretched film was then blown to dry in air at 135° C. for 20 minutes, to prepare a transparent support. The thus prepared support contained the solvent remaining in the amount of 0.3 wt. %.

The prepared support had the width of 1,340 mm and the thickness of 92 μm.

The prepared transparent support was left at the temperature of 20° C. under the relative humidity of 20% for 2 hours, and then the retardation value (Re) was measured at the wavelength of 590 nm by means of an ellipsometer (M-150, JASCO COORPORATION). As a result, the Re value was found 38.0 nm. The retardation value (Rth) was also measured at the wavelength of 590 nm, to find 175.0 nm.

Successively, after the support was left at the temperature of 10° C. under the relative humidity of 20% for 2 hours, the retardation value (Re) was measured at the wavelength of 590 nm in the same manner as above, to find 37.7 nm. The retardation value (Rth) was also measured at the wavelength of 590 nm, to find 175.2 nm.

The surface of transparent support was coated with 10 ml/m² of 1.0 N potassium hydroxide solution (solvent: water/isopropyl alcohol/propylene glycol=69.2 weight parts/15 weight parts/15.8 weight parts), kept at approx. 40° C. for 30 seconds, wiped and washed with water to remove the alkaline solution, and then drops of water were blown away with an air-knife. After the surface thus treated with the alkali was dried at 100° C. for 15 seconds, the contact angle with pure water was measured to find 42°.

(Formation of Orientation Layer)

The alkali-treated surface of the support was coated with the following coating solution for orientation layer in the amount of 28 ml/m² by means of a wire bar coater of #16. The spread solution was dried with hot air at 60° C. for 60 seconds, and then further dried with hot air at 90° C. for 150 seconds to form an orientation layer.

Coating solution for orientation layer

| | |
|---|---|
| The following denatured polyvinyl alcohol | 10 weight parts |
| Water | 371 weight parts |
| Methanol | 119 weight parts |
| Glutaric aldehyde (cross-linking agent) | 0.5 weight part |
| Citric ester (AS3, Sankio Chemical Co., Ltd.) | 0.35 weight part |

(Denatured Polyvinyl Alcohol) 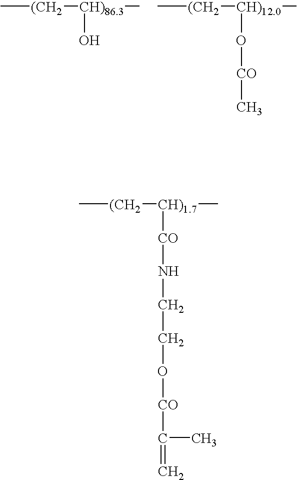
(Rubbing Treatment)

The transparent support on which the orientation layer was provided was transferred at the speed of 20 m/minute. A rubbing roller (diameter: 300 mm) was set so that the transferred support could be subjected to rubbing treatment in which the rubbing direction was at the angle of 45° to the longitudinal direction, and rotated at 650 rpm. Thus, the surface of orientation layer was subjected to the rubbing treatment. The contact length between the roller and the support was 18 mm.

(Formation of Optically Anisotropic Layer)

In 102 kg of methyl ethyl ketone, 41.01 kg of the following discotic liquid crystal compound, 4.06 kg of ethylene oxide denatured trimethlolpropanetriacrylate (V#360, Osaka Organic Chemicals Co., Ltd.), 0.45 kg of cellulose acetate butyrate (CAB-531-1, Eastman Chemical), 1.35 kg of a photopolymerization initiator (Irgacure 907, Ciba-Geigy) and 0.45 kg of a sensitizer (Kayacure DETX, Nippon Kayaku Co., Ltd.) were dissolved to prepare a coating solution. While the transparent support was transferred at 20 m/minute, the coating solution was continuously spread to coat the orientation layer on the support by means of a wire-bar of #3.0 rotating at 391 rpm so that the rotation might follow the transference.

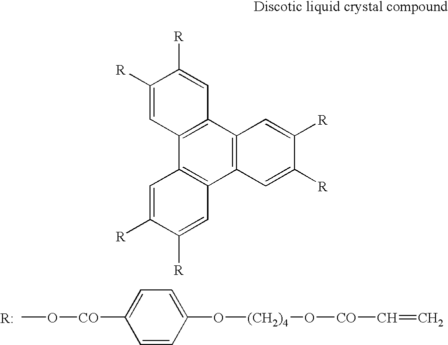

The temperature was continuously raised from room temperature to 100° C., to dry the spread solution. The coated support was then transferred to a drying zone heated at 130° C., and blown with air for approx. 90 seconds so that molecules of the discotic liquid crystal compound might be aligned. In the drying zone, the air was made to flow at the speed of 2.5 m/sec near the surface of support. Successively, the support was further transferred to another drying zone heated at 80° C., and exposed to ultraviolet rays of 600 mW for 4 seconds with the surface of support heated at approx. 100° C. (surface temperature). The ultraviolet rays were emitted from a UV exposure apparatus (power of UV lamp: 160 W/cm, length of lamp: 1.6 m). Thus, the aligned discotic liquid crystal molecules were fixed. After cooled to room temperature, the film was cylindrically wound up into a roll to produce a rolled optical compensatory sheet.

The viscosity of the formed optically anisotropic layer was measured at the surface temperature of 127° C., and found 695 cp. In the measurement, a liquid crystal layer comprising the same components (except the solvent) as the optically anisotropic layer was prepared and its viscosity was measured with an E-viscosimeter of heating type to estimate the viscosity of the optically anisotropic layer.

A piece of the rolled optical compensatory sheet was clipped and used as the sample in the following evaluations of optical characters.

The optical compensatory sheet was left at the temperature of 20° C. under the relative humidity of 20% for 2 hours, and then the retardation value (Re) was measured at the wavelength of 590 nm by means of an ellipsometer (M-150, JASCO COORPORATION). As a result, the Re value was found 30.0 nm. It was also found that, in the optically anisotropic layer, the angle between the discotic plane of discotic liquid crystal molecule and the surface of support (namely, inclined angle) varied continuously according the depth and was 28° on average. Further, after only the optically anisotropic layer was peeled from the sample, the average direction of lines of molecular symmetry in the optically anisotropic layer was measured and found that the lines of molecular symmetry were oriented on average at 45° to the longitudinal direction.

Successively, after the compensatory sheet was left at the temperature of 10° C. under the relative humidity of 20% for 2 hours, the retardation value (Re) was measured at the wavelength of 590 nm in the same manner as above, to find 30.0 nm.

The polarizing plates were arranged in cross-Nicol position, and then it was observed whether an image given by the optical compensatory sheet had defects or not. As a result, no defect was observed when the sheet was seen frontally or obliquely at 60° to the normal.

(Preparation of Polarizing Plate)

The optical compensatory sheet was laminated with a polyvinyl alcohol adhesive on a polarizing membrane so that the support-side of the sheet might be in contact with the membrane. On the other hand, a commercially available triacetyl cellulose film (thickness: 80 μm, TD-80U, Fuji Photo Film Co., Ltd.) was saponified and laminated on the opposite surface of the polarizing membrane with the polyvinyl alcohol adhesive.

The polarizing membrane, the transparent support and the saponified commercially available triacetyl cellulose film were placed so that their longitudinal directions might be parallel to each other. Thus, a polarizing plate comprising the optical compensatory sheet was produced.

Independently, the optical compensatory sheet was laminated with a polyvinyl alcohol adhesive on a polarizing membrane so that the support-side of the sheet might be in contact with the membrane. On the other hand, a commercially available anti-reflection film (Clear View UA, Fuji Photo Film Co., Ltd.) was saponified and laminated on the opposite surface of the polarizing membrane with the polyvinyl alcohol adhesive.

The polarizing membrane, the transparent support and the saponified anti-reflection film were placed so that their longitudinal directions might be parallel to each other. Thus, a polarizing plate comprising the optical compensatory sheet and the anti-reflection film was produced.

(Preparation of Liquid Crystal Cell of Bend Alignment)

On a glass plate having an ITO electrode, an orientation layer of polyimide was provided and subjected to a rubbing treatment. This procedure was repeated to prepare two substrates, and the substrates were arranged face-to-face so that the rubbing directions might be parallel and so that the gap might be 4.5 μm. Between them, a liquid crystal having Δn of 0.1396 (ZLI1132, Merck & Co., Inc.) was introduced to prepare a liquid crystal cell of bend alignment. The size of the cell was 20 inches.

(Preparation of Liquid Crystal Display)

The polarizing plate comprising the optical compensatory sheet (without the anti-reflection film) and the plate comprising both of the compensatory sheet and the anti-reflection film were laminated on the liquid crystal cell, so that the cell might be between the plates and so that the plate comprising both compensatory sheet and anti-reflection film might be on the viewer side. The plates were arranged so that the optically anisotropic layer in each plate might face to the cell substrate and so that the rubbing directions of the cell and the optically anisotropic layer might be anti-parallel.

(Evaluation of Liquid Crystal Display)

Voltage of a square wave (55 Hz) was applied to the liquid crystal cell. An image was displayed according to normally white mode (white: 2V, black: 5V). A ratio of transmittance (white/black) was measured by means of a meter (EZ-Contrast 160D, ELDIM) at eight displaying states of L1 (full black) to L8 (full white), to determine the contrast ratio. A front contrast (CR: ratio of brightness in displaying a white image/a black image) was also measured.

The measurements were conducted at the temperature of 20° C. under the relative humidity of 20%, and repeated at the temperature of 10° C. under the relative humidity of 20%.

The results are set forth in Table 1.

The liquid crystal display was adjusted to display an image of full half tone, and it was observed whether the displayed image had defects or not. As a result, no defect was observed when the display was seen in any direction.

### EXAMPLE 2

The cellulose acetate solution and the retardation increasing agent solution prepared in Example 1 were mixed and stirred well to prepare a dope. The prepared dope contained the retardation-increasing agent in the amount of 7.5 weight parts based on 100 weight parts of cellulose acetate.

The prepared dope was cast on a band by means of a band-casting machine. The formed film was stretched in the same manner as in Example 1 except that the stretching ratio was changed into 20%, to prepare a transparent support containing the solvent remaining in the amount of 0.3 wt. %.

The prepared transparent support had the width of 1,500 mm and the thickness of 95 μm.

The prepared support was left at the temperature of 20° C. under the relative humidity of 20% for 2 hours, and then the retardation value (Re) was measured at the wavelength of 590 nm by means of an ellipsometer (M-150, JASCO COORPORATION). As a result, the Re value was found 35.0 nm. The retardation value (Rth) was also measured at the wavelength of 590 nm, to find 200.0 nm.

Successively, after the support was left at the temperature of 10° C. under the relative humidity of 20% for 2 hours, the retardation value (Re) was measured at the wavelength of 590 nm in the same manner as above, to find 35.3 nm. The retardation value (Rth) was also measured at the wavelength of 590 nm, to find 200.2 nm.

The transparent support was immersed at 25° C. for 2 minutes in 2.0 N potassium hydroxide solution, neutralized with sulfuric acid, washed with pure water, and dried. The surface energy of the thus-treated support was measured according to the contact angle method, to find 63 mN/m.

(Formation of Orientation Layer)

The following coating solution was spread to coat the transparent support in the amount of 28 ml/m² by means of a wire bar coater of #16. The spread solution was dried with hot flowing air at 60° C. for 60 seconds, and then further dried with hot flowing air at 90° C. for 150 seconds.

Coating solution for orientation layer

| | | |
|---|---|---|
| The denatured polyvinyl alcohol used in Example 1 | 10 | weight parts |
| Water | 371 | weight parts |
| Methanol | 119 | weight parts |
| Glutaric aldehyde (cross-linking agent) | 0.5 | weight part |
| Citric ester (AS3, Sankio Chemical Co., Ltd.) | 0.35 | weight part |

(Rubbing Treatment)

The transparent support was transferred at the speed of 20 m/minute. A rubbing roller (diameter: 300 mm) was set so that the transferred support could be subjected to rubbing treatment in which the rubbing direction was at the angle of 45° to the longitudinal direction, and rotated at 450 rpm. Thus, the surface of the orientation layer was subjected to the rubbing treatment.

(Formation of Optically Anisotropic Layer)

In 102 kg of methyl ethyl ketone, 41.01 kg of the discotic liquid crystal compound used in Example 1, 4.06 kg of ethylene oxide denatured trimethlolpropanetriacrylate (V#360, Osaka Organic Chemicals Co., Ltd.), 0.29 kg of cellulose acetate butyrate (CAB-531-1, Eastman Chemical), 1.35 kg of a photopolymerization initiator (Irgacure 907, Ciba-Geigy), 0.45 kg of a sensitizer (Kayacure DETX, Nippon Kayaku Co., Ltd.) and 0.45 kg of citric ester (AS3, Sankio Chemical Co., Ltd.) were dissolved, and 0.1 kg of the following fluoroaliphatic group-containing copolymer was added to prepare a coating solution. While the transparent support was transferred at 20 m/minute, the coating solution was continuously spread to coat the orientation layer on the support by means of a wire-bar of #2.7 rotating at 391 rpm so that the rotation might follow the transference.
Fluoroaliphatic Group-Containing Copolymer

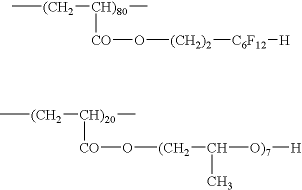

The temperature was continuously raised from room temperature to 100° C., to dry the spread solution. The coated support was then transferred to a drying zone heated at 135° C., and blown with air flowing at 1.5 m/sec for approx. 90 seconds so that molecules of the discotic liquid crystal compound might be aligned. Successively, the support was further transferred to another drying zone heated at 80° C., and exposed to ultraviolet rays of 600 mW for 4 seconds with the surface of support heated at approx. 100° C. (surface temperature). The ultraviolet rays were emitted from a UV exposure apparatus (power of UV lamp: 160 W/cm, length of lamp: 1.6 m). Thus, the aligned discotic liquid crystal molecules were cross-linked and thereby fixed. After cooled to room temperature, the film was cylindrically wound up into a roll to produce a rolled optical compensatory sheet.

The viscosity of the optically anisotropic layer was measured at the surface temperature of 131° C., and found 600 cp. In the measurement, a liquid crystal layer comprising the same components (except the solvent) as the optically anisotropic layer was prepared and its viscosity was measured with an E-viscosimeter of heating type to estimate the viscosity of the optically anisotropic layer.

A piece of the rolled optical compensatory sheet was clipped and used as the sample in the following evaluations of optical characters.

The optical compensatory sheet was left at the temperature of 20° C. under the relative humidity of 20% for 2 hours, and then the retardation value (Re) was measured at the wavelength of 590 nm by means of an ellipsometer (M-150, JASCO COORPORATION). As a result, the Re value was found 28.0 nm. It was also found that, in the optically anisotropic layer, the angle between the discotic plane of discotic liquid crystal molecule and the surface of support (namely, inclined angle) varied continuously according the depth and was 33° on average. Further, after only the optically anisotropic layer was peeled from the sample, the average direction of lines of molecular symmetry in the optically anisotropic layer was measured and found that the lines of molecular symmetry were oriented on average at 45.5° to the longitudinal direction.

Successively, after the compensatory sheet was left at the temperature of 10° C. under the relative humidity of 20% for 2 hours, the retardation value (Re) was measured at the wavelength of 590 nm in the same manner as above, to find 28.0 nm.

The polarizing plates were arranged in cross-Nicol position, and then it was observed whether an image given by the optical compensatory sheet had defects or not. As a result, no defect was observed when the sheet was seen frontally or obliquely at 60° to the normal.

(Preparation of Polarizing Plate)

The optical compensatory sheet was laminated with a polyvinyl alcohol adhesive on a polarizing membrane so that the support-side of the sheet might be in contact with the membrane. On the other hand, a commercially available triacetyl cellulose film (thickness: 80 μm, TD-80U, Fuji Photo Film Co., Ltd.) was saponified and laminated on the opposite surface of the polarizing membrane with the polyvinyl alcohol adhesive.

The polarizing membrane, the transparent support and the saponified commercially available triacetyl cellulose film were placed so that their longitudinal directions might be parallel to each other. Thus, a polarizing plate was produced.

(Preparation of Liquid Crystal Cell of Bend Alignment)

On a glass plate having an ITO electrode, an orientation layer of polyimide was provided and subjected to a rubbing treatment. This procedure was repeated to prepare two substrates, and the substrates were arranged face-to-face so that the rubbing directions might be parallel and so that the gap might be 6 μm. Between them, a liquid crystal having Δn of 0.1396 (ZLI1132, Merck & Co., Inc.) was introduced to prepare a liquid crystal cell of bend alignment. The size of the cell was 20 inches.

(Preparation of Liquid Crystal Display)

Two polarizing plates prepared above were laminated on the liquid crystal cell so that the cell might be between the plates. The plates were arranged so that the optically anisotropic layer in each plate might face to the cell substrate and so that the rubbing directions of the cell and the optically anisotropic layer might be anti-parallel.

(Evaluation of Liquid Crystal Display)

Voltage of a square wave (55 Hz) was applied to the liquid crystal cell. An image was displayed according to normally white mode (white: 2V, black: 6V). A ratio of transmittance (white/black) was measured by means of a meter (EZ-Contrast 160D, ELDIM) at eight displaying states of L1 (full black) to L8 (full white), to determine the contrast ratio. A front contrast (CR: ratio of brightness in displaying a white image/a black image) was also measured.

The measurements were conducted at the temperature of 20° C. under the relative humidity of 20%, and repeated at the temperature of 10° C. under the relative humidity of 20%.

The results are set forth in Table 1.

The liquid crystal display was adjusted to display an image of full half tone, and it was observed whether the displayed image had defects or not. As a result, no defect was observed when the display was seen in any direction.

### COMPARISON EXAMPLE 1

(Preparation of Transparent Support)

The following components were poured into a mixing tank, and stirred and heated to dissolve each component. Thus, a cellulose acetate solution was prepared.

Cellulose acetate solution

| | | |
|---|---|---|
| Cellulose acetate (acetic acid content: 60.9%) | 100 | weight parts |
| Triphenyl phosphate (plasticizer) | 7.8 | weight parts |
| Biphenyldiphenyl phosphate (plasticizer) | 3.9 | weight parts |
| Methylene chloride (first solvent) | 300 | weight parts |
| Methanol (second solvent) | 45 | weight parts |
| Dye (360FP, Sumika Fine Chemicals Co., Ltd.) | 0.0009 | weight part |

In 499 weight parts of the cellulose acetate solution, 1.1 weight parts of silica fine particles (Aerosil R972) was mixed and stirred well to prepare a dope. The prepared dope contained the silica fine particles in the amount of 0.15 weight part based on 100 weight parts of cellulose acetate.

The dope was cast on a band by means of a band-casting machine (width: 2 m, length: 65 m). After the surface temperature of the dope on the band reached 40° C., the dope was dried for 1 minute. After peeled from the band, the film was laterally stretched by 20% by means of a tenter while exposed to flowing air at 140° C. The stretched film was then blown to dry in air at 135° C. for 60, minutes. Thus, a transparent support containing the solvent remaining in the amount of 1.3 wt. % was prepared.

The prepared support had the width of 1,340 mm and the thickness of 280 μm.

The prepared transparent support was left at the temperature of 20° C. under the relative humidity of 20% for 2 hours, and then the retardation value (Re) was measured at the wavelength of 590 nm by means of an ellipsometer (M-150, JASCO COORPORATION). As a result, the Re value was found 25.0 nm. The retardation value (Rth) was also measured at the wavelength of 590 nm, to find 155.0 nm.

Successively, after the support was left at the temperature of 10° C. under the relative humidity of 20% for 2 hours, the retardation value (Re) was measured at the wavelength of 590 nm in the same manner as above, to find 21.8 nm. The retardation value (Rth) was also measured at the wavelength of 590 nm, to find 152.8 nm.

The surface of transparent support was coated with 10 ml/m² of 1.0 N potassium hydroxide solution (solvent: water/isopropyl alcohol/propylene glycol=69.2 weight parts/15 weight parts/15.8 weight parts), kept at approx. 40° C. for 30 seconds, wiped and washed with water to remove the alkaline solution, and then drops of water were blown away with an air-knife. After the surface thus treated with the alkali was dried at 100° C. for 15 seconds, the contact angle with pure water was measured to find 42°.

(Formation of Orientation Layer)

The following coating solution was spread to coat the transparent support in the amount of 28 ml/m² by means of a wire bar coater of #16. The spread solution was dried with hot air at 60° C. for 60 seconds, and then further dried with hot air at 90° C. for 150 seconds.

Coating solution for orientation layer

| | | |
|---|---|---|
| The denatured polyvinyl alcohol used in Example 1 | 10 | weight parts |
| Water | 371 | weight parts |
| Methanol | 119 | weight parts |
| Glutaric aldehyde (cross-linking agent) | 0.5 | weight part |

(Rubbing Treatment)

The transparent support on which the orientation layer was provided was transferred at the speed of 20 m/minute. A rubbing roller (diameter: 300 mm) was set so that the transferred support could be subjected to rubbing treatment in which the rubbing direction was at the angle of 45° to the longitudinal direction, and rotated at 650 rpm. Thus, the surface of orientation layer was subjected to the rubbing treatment. The contact length between the roller and the support was 18 mm.

(Formation of Optically Anisotropic Layer)

In 102 kg of methyl ethyl ketone, 41.01 kg of the discotic liquid crystal compound used in Example 1, 4.06 kg of ethylene oxide denatured diacrylate, 0.58 kg of cellulose acetate butyrate (CAB-531-1, Eastman Chemical), 1.35 kg of a photopolymerization initiator (Irgacure 907, Ciba-Geigy) and 0.45 kg of citric ester (AS3, Sankio Chemical Co., Ltd.) were dissolved to prepare a coating solution. While the transparent support was transferred at 20 m/minute, the coating solution was continuously spread to coat the orientation layer on the support by means of a wire-bar of #3.6 rotating at 391 rpm so that the rotation might follow the transference.

The temperature was continuously raised from room temperature to 100° C., to dry the spread solution. The coated support was then transferred to a drying zone heated at 135° C., and blown with air flowing at 1.5 m/sec for approx. 60 seconds so that molecules of the discotic liquid crystal compound might be aligned. Successively, the support was further transferred to another drying zone heated at 20° C., and exposed to ultraviolet rays of 100 mW for 1 second with the surface of support heated at approx. 100° C. (surface temperature). The ultraviolet rays were emitted from a UV exposure apparatus (power of UV lamp: 160 W/cm, length of lamp: 1.6 m). Thus, the aligned discotic liquid crystal molecules were cross-linked and thereby fixed. After cooled to room temperature, the film was cylindrically wound up into a roll to produce a rolled optical compensatory sheet.

A piece of the rolled optical compensatory sheet was clipped and used as the sample in the following evaluations of optical characters.

The optical compensatory sheet was left at the temperature of 20° C. under the relative humidity of 20% for 2 hours, and then the retardation value (Re) was measured at the wavelength of 590 nm by means of an ellipsometer (M-150, JASCO COORPORATION). As a result, the Re value was found 40.0 nm. It was also found that, in the optically anisotropic layer, the angle between the discotic plane of discotic liquid crystal molecule and the surface of support (namely, inclined angle) varied continuously according the depth and was 33° on average. Further, after only the optically anisotropic layer was peeled from the sample, the average direction of lines of molecular symmetry in the optically anisotropic layer was measured and found that the lines of molecular symmetry were oriented on average at 37.0° to the longitudinal direction.

Successively, after the compensatory sheet was left at the temperature of 10° C. under the relative humidity of 20% for 2 hours, the retardation value (Re) was measured at the wavelength of 590 nm in the same manner as above, to find 41.3 nm.

(Preparation of Polarizing Plate)

The procedure of Example 2 was repeated except that the above-prepared optical compensatory sheet was used, to produce a polarizing plate.

(Preparation and Evaluation of Liquid Crystal Display)

The procedure of Example 2 was repeated except that the above-prepared polarizing plate was used, to produce and evaluate a liquid crystal display.

The results are set forth in Table 1.

The liquid crystal display was adjusted to display an image of full half tone, and it was observed whether the displayed image had defects or not. As a result, a latticed pattern due to unevenness was observed when the display was seen at an upper viewing angle of 55° or more or at a lower viewing angle of 60° or more. When seen at that angle, the display gave an inverse image.

TABLE 1

| | 20° C., 20% RH | | | 10° C., 20% RH | | |
|---|---|---|---|---|---|---|
| Optical | | Viewing angle | | | Viewing angle | |
| compensatory | Front | Up/ | Left/ | Front | Up/ | Left/ |
| sheet | contrast | down | right | contrast | down | right |
| Example 1 | 480 | 80/80 | 80/80 | 485 | 80/80 | 80/80 |
| Example 2 | 530 | 80/80 | 80/80 | 525 | 80/80 | 80/80 |
| Comp. Ex. 1 | 400 | 60/60 | 70/65 | 300 | 45/45 | 60/50 |

Remarks)

Viewing angle: an angle range (in terms of degree) giving a contrast ratio of 10 or more.

1. An optical compensatory sheet comprising a cellulose acylate film, wherein the retardation value in plane measured at the temperature of 20° C. under the relative humidity of 20% is in the range of 97 to 103% based on the retardation value in plane measured at the temperature of 10° C. under the relative humidity of 20%.

2. The optical compensatory sheet as defined in claim 1, wherein the cellulose acylate film contains a hydrophobic compound having a molecular weight in the range of 200 to 700 and 2 or less oxygen atoms in an amount of 4 to 15 wt. % based on the amount of cellulose acylate.

3. The optical compensatory sheet as defined in claim 2, wherein the hydrophobic compound has one or no oxygen atom.

4. The optical compensatory sheet as defined in claim 1, wherein the cellulose acylate film comprises cellulose acetate having acetic acid content in the range of 55.0 to 62.5%.

5. A liquid crystal display comprising a liquid crystal cell provided between two polarizing plates, polarizing plate, wherein the liquid crystal display further comprises an optical compensatory sheet between the liquid crystal cell and the polarizing plate, said optical compensatory sheet comprising a cellulose acylate film, and wherein the retardation value in plane measured at the temperature of 20° C. under the relative humidity of 20% is in the range of 97 to 103% based on the retardation value in plane measured at the temperature of 10° C. under the relative humidity of 20%.

6. The liquid crystal display as defined in claim 5, wherein the liquid crystal display has a response time of 300 ms or less.

7. The liquid crystal display as defined in claim 5, wherein the liquid crystal cell works according to OCB mode.

8. A liquid crystal display comprising a reflection board, a liquid crystal cell and a polarizing plate in order, wherein the liquid crystal display further comprises an optical compensatory sheet between the liquid crystal cell and the polarizing plate, said optical compensatory sheet comprising a cellulose acylate film, and wherein the retardation value in plane measured at the temperature of 20° C. under the relative humidity of 20% is in the range of 97 to 103% based on the retardation value in plane measured at the temperature of 10° C. under the relative humidity of 20%.

9. The liquid crystal display as defined in claim 8, wherein the liquid crystal display has a response time of 300 ms or less.

10. An optical compensatory sheet comprising a transparent support and an optically anisotropic layer formed from a liquid crystal compound, wherein the retardation value in plane measured at the temperature of 20° C. under the relative humidity of 20% is in the range of 97 to 103% based on the retardation value in plane measured at the temperature of 10° C. under the relative humidity of 20%.

11. The optical compensatory sheet as defined in claim 10, wherein the transparent support comprises a cellulose acylate film.

12. The optical compensatory sheet as defined in claim 11, wherein the retardation value in plane of the cellulose acylate film measured at the temperature of 20° C. under the relative humidity of 20% is in the range of 97 to 103% based on the retardation value in plane of the cellulose acylate film measured at the temperature of 10° C. under the relative humidity of 20%.

13. The optical compensatory sheet as defined in claim 12, wherein the cellulose acylate film contains a hydrophobic compound having a molecular weight in the range of 200 to 700 and 2 or less oxygen atoms in an amount of 4 to 15 wt. % based on the amount of cellulose acylate.

14. The optical compensatory sheet as defined in claim 13, wherein the hydrophobic compound has one or no oxygen atom.

15. The optical compensatory sheet as defined in claim 11, wherein the cellulose acylate film comprises cellulose acetate having acetic acid content in the range of 55.0 to 62.5%.

16. A liquid crystal display comprising a liquid crystal cell provided between two polarizing plates, polarizing plate, wherein the liquid crystal display further comprises an optical compensatory sheet between the liquid crystal cell and the polarizing plate, said optical compensatory sheet comprising a transparent support and an optically anisotropic layer formed from a liquid crystal compound, and wherein the retardation value in plane measured at the temperature of 20° C. under the relative humidity of 20% is in the range of 97 to 103% based on the retardation value in plane measured at the temperature of 10° C. under the relative humidity of 20%.

17. The liquid crystal display as defined in claim 16, wherein the liquid crystal display has a response time of 300 ms or less.

18. The liquid crystal display as defined in claim 16, wherein the liquid crystal cell works according to OCB mode.

19. A liquid-crystal display comprising a reflection board, a liquid crystal cell and a polarizing plate in order, wherein the liquid crystal display further comprises an optical compensatory sheet between the liquid crystal cell and the polarizing plate, said optical compensatory sheet comprising a cellulose acylate film, and wherein the retardation value in plane measured at the temperature of 20° C. under the relative humidity of 20% is in the range of 97 to 103% based on the retardation value in plane measured at the temperature of 10° C. under the relative humidity of 20%.

20. The liquid crystal display as defined in claim 19, wherein the liquid crystal display has a response time of 300 ms or less.
